(19) United States
(12) Patent Application Publication
(10) Pub. No.: US 2025/0051560 A1
(43) Pub. Date: Feb. 13, 2025

(54) RUBBER-REINFORCED VINYLAROMATIC (CO)POLYMERS AND PROCESS FOR THE PREPARATION THEREOF

(71) Applicant: VERSALIS S.P.A., San Donato Milanese (MI) (IT)

(72) Inventors: Leonardo CHIEZZI, Mantova (MN) (IT); Nicola FIOROTTO, Mantova (MN) (IT); Leonardo CASTELLANI, Mantova (MN) (IT)

(21) Appl. No.: 18/718,337

(22) PCT Filed: Dec. 5, 2022
(86) PCT No.: PCT/IB2022/061776

§ 371 Date: Jun. 10, 2024

(30) Foreign Application Priority Data
Dec. 10, 2021 (IT) 102021000031067

(51) Int. Cl. C08L 25/12; C08F 2/00; C08F 2/01; C08F 2/44; C08F 279/04

(52) U.S. Cl. CPC C08L 25/12; C08F 2/001; C08F 2/01; C08F 2/44; C08F 279/04; C08L 2205/22; C08L 2314/00

(57) ABSTRACT

A rubber-reinforced vinyl aromatic (co)polymer having (a) a polymeric matrix comprising at least one vinyl aromatic monomer and at least one comonomer;
(b) rubber particles obtained by a continuous mass process from functionalised low cis polybutadiene rubber dispersed therein, wherein:
(i) the average volumetric diameter of the rubber particles is between 0.25 □m and 0.37 □m;
(ii) the volume of the rubber particles having a diameter greater than 0.40 □m is between 20% and 50%, with respect to the total volume of the dispersed rubber particles;
(iii) the ratio between rubber particles containing occlusions and rubber particles without occlusions is between 0.9 and 1.9.

The aforementioned rubber-reinforced vinyl aromatic (co)polymer has high aesthetic properties, in particular in terms of gloss and gloss sensitivity, and mechanical properties, in particular in terms of impact resistance and puncture resistance.

The aforementioned rubber-reinforced vinyl aromatic (co)polymer may be used in various applications, like injection moulding.

### CROSS-REFERENCE TO RELATED APPLICATIONS

This application is a 35 U.S.C. § 371 National Stage patent application of PCT/IB2022/061776, filed on May 12, 2022, which claims the benefit of Italian patent application 102021000031067, filed on Oct. 12, 2021, the disclosures of which are incorporated herein by reference in their entirety.

### TECHNICAL FIELD

The present disclosure relates to rubber-reinforced vinyl aromatic (co)polymers.

More in particular, the present disclosure relates to a rubber-reinforced vinyl aromatic (co)polymer comprising: (a) a polymeric matrix comprising at least one vinyl aromatic monomer and at least one comonomer; rubber particles obtained through a continuous mass process from functionalised low cis polybutadiene rubber (LCBR) dispersed therein, having specific characteristics in terms of size and morphology.

The aforementioned rubber-reinforced vinyl aromatic (co)polymer has high aesthetic properties, in particular in terms of gloss and gloss sensitivity, and mechanical properties, in particular in terms of impact resistance and puncture resistance.

The aforementioned rubber-reinforced vinyl aromatic (co)polymer can be advantageously used in various applications, for example, injection moulding.

The present disclosure provides a process for the preparation of the aforementioned rubber-reinforced vinyl aromatic (co)polymer.

### BACKGROUND

It is known that the balance of the aesthetic and mechanical properties of rubber-reinforced vinyl aromatic (co)polymers depend on the rubber concentration in the finished (co)polymer and on the average volumetric diameters distribution of the rubber particles dispersed in the polymer matrix.

For example, in order to obtain a rubber-reinforced vinyl aromatic (co)polymer, for example an acrylonitrile-butadiene-styrene (ABS) copolymer, having good mechanical properties and high surface gloss, it is necessary that the concentration of rubber in the copolymer is higher than 13% by mass and that the rubber particles have an average volumetric diameter of less than 0.5 μm and a wide distribution of volumetric diameters between 0.1 μm and 0.5 μm, preferably bimodal. In the event that one of these parameters is not met, the desired mechanical properties and surface gloss will not be obtained and the (co)polymer obtained will therefore not be suitable for the final application. For example, a rubber-reinforced vinyl aromatic (co)polymer having a rubber particle content of 15% by mass having an average volumetric diameter of particles of 0.2 μm and a narrow distribution of the volumetric diameter between 0.1 μm and 0.3 μm, will have a high surface gloss, but will not have good mechanical properties.

The morphology of the rubber particles dispersed in the polymer matrix is also very important in defining the aesthetic and mechanical properties of the rubber-reinforced vinyl aromatic (co)polymer. In order to precisely regulate these properties, it is necessary that the elastomeric phase (i.e. the rubber particles) dispersed in the polymeric matrix comprises particles having a small to medium volumetric diameter (generally less than 0.3 μm) and spherical or capsule morphology (with a single occlusion) and particles having a larger average volumetric diameter (between 0.3 μm and 0.5 μm) with a “salami” (or multi-occlusion) morphology.

For example, EP patent 0390781 and U.S. Pat. No. 4,713,420 relate to rubber-modified acrylonitrile-butadiene-styrene (ABS) copolymers comprising three different types of rubber particles. In particular, said rubber particles are: 1) rubber particles produced by an emulsion process having a small average volumetric diameter between 0.05 μm and 0.25 μm; 2) rubber particles produced by an emulsion process having a large average volumetric diameter between 0.4 μm and 2 μm; e 3) rubber particles produced by a mass process having a large average volumetric diameter between 0.5 μm and 10 μm. In particular, said patents show how rubber particles having an average volumetric diameter greater than 0.5 μm promote the mechanical properties of the copolymer, but penalize its aesthetic properties, in particular its gloss. Therefore, in order to ensure the right balance of mechanical and aesthetic properties, in said patents, the rubber-modified acrylonitrile-butadiene-styrene (ABS) copolymers are obtained by precisely mixing the various components, in particular the various rubber particles based on their average volumetric diameter and their morphology. The rubber-modified acrylonitrile-butadiene-styrene (ABS) copolymers of the above patents are said to have an excellent balance of aesthetic and mechanical properties.

U.S. Pat. No. 6,211,298 relates to an improved rubber modified polymeric composition comprising: (a) a continuous phase matrix comprising an interpolymer of a monovinylidene aromatic monomer and an ethylenically unsaturated nitrile monomer; and (b) from 5% by weight to 40% by weight, with respect to the total weight of said polymeric composition, of discrete rubber particles dispersed in said matrix, wherein said dispersed rubber particles comprise: (1) at least 33% by weight with respect to the total rubber content, of rubber particles produced by a mass process having an average volumetric diameter between 0.15 μm and 0.40 μm; (2) from 15% by weight to 67% by weight with respect to the total rubber content, of rubber particles produced by an emulsion process, having a small average volumetric diameter between 0.05 μm and 0.30 μm; and (3) from 0% by weight to 35% by weight with respect to the total rubber content, of rubber particles produced by an emulsion process having a large average volumetric diameter greater than 0.30 μm, up to 2.0 μm; wherein said rubber particles have an average light absorbance ratio lower than 1.4. The aforementioned composition containing a high percentage of rubber particles produced in mass having a small to medium volumetric diameter, is said to be cheaper and able to maintain an excellent gloss and good impact properties. The aforementioned composition is also said to have improved thermal and colour stability compared to similar compositions having similar gloss and gloss sensitivity.

The rubber particles, as known in the art, can be produced through two types of processes, i.e., emulsion polymerisation processes and continuous mass polymerisation processes.

It is known that, in emulsion polymerisation processes, the size of the rubber particles is adjusted at will in the early stages of the process by radical polymerisation of butadiene in an aqueous emulsion. The rubber particles having defined dimensions are then subjected to grafting with styrene and acrylonitrile. The product of this reaction, called grafted acrylonitrile-butadiene-styrene (ABS) copolymer is characterised by high concentrations of polybutadiene: the presence of styrene-acrylonitrile (SAN) copolymer chemically grafted to the polybutadiene particles is of fundamental importance for the compatibilization of polybutadiene in the styrene-acrylonitrile (SAN) copolymer, since the two polymers are incompatible with each other. The emulsion production process of the acrylonitrile-butadiene-styrene (ABS) copolymer involves a compounding step of the grafted acrylonitrile-butadiene-styrene (ABS) copolymer with the styrene-acrylonitrile (SAN) copolymer produced separately, in order to obtain the desired product. More details on said emulsion polymerisation process can be found, for example, in Bouquet G., “Rubber Particle Formation in Mass ABS, Modern Styrenic Polymers: Polystyrenes and Styrenic Copolymers” (2003), Chapter 14, pg. 305-319, Edited by J. Scheirs and D.B. Priddy, Wiley & Sons.

In the continuous mass polymerisation process, on the other hand, the formation of the rubber particles dispersed in the matrix takes place starting from a solution of polybutadiene dissolved in a mixture of monomer (styrene) and diluent (normally ethylbenzene) to which the second monomer is added (acrylonitrile) just prior to the continuous mass polymerisation reaction. This precaution is necessary because, at the temperatures at which the dissolution of the rubber is carried out, the presence of acrylonitrile would cause the rubber precipitation. Once the reaction mixture has been prepared, it is subjected to a radical polymerisation process: as the radical polymerisation reaction proceeds, styrene-acrylonitrile (SAN) copolymer domains are formed in a mixture of polybutadiene-monomers-diluent in which the main polymeric phase is the polybutadiene phase. At a certain degree of monomer conversion, the volume of polybutadiene phase and the volume of styrene-acrylonitrile (SAN) copolymer phase in the reaction system will be equal: this moment is called phase inversion. Proceeding with the conversion of monomers in the formation of the styrene-acrylonitrile (SAN) copolymer, in the reaction mixture the main phase will be constituted by the styrene-acrylonitrile (SAN) copolymer and the dispersed phase by polybutadiene particles dispersed in the main phase of styrene-acrylonitrile (SAN) copolymer. In the moments immediately following the phase inversion phenomenon, the diameter and morphology of the dispersed rubber particles are defined.

It is also known that the main parameters that influence the diameter and morphology of the rubber particles are:
the shear stress (or “shear”) imposed on the reaction mixture;
the interfacial tension between the two polymeric phases [polybutadiene and styrene-acrylonitrile (SAN) copolymer] present in the reaction mixture;
the viscosity ratio between the polybutadiene phase and the styrene-acrylonitrile (SAN) copolymer phase.

Furthermore, in the continuous mass polymerisation process in order to obtain an acrylonitrile-butadiene-styrene (ABS) copolymer containing rubber particles having an average volumetric diameter of less than 0.5 μm and to maximise the gloss and mechanical properties of the final product, it is necessary to:
maximise the shear stress (shear) imposed on the reaction mixture by mechanical stirring;
appropriately regulate the formation of grafted copolymer to precisely regulate the interfacial tension;
minimise the viscosity ratio between the polybutadiene phase and the styrene-acrylonitrile (SAN) copolymer phase and, therefore, the need to use low viscosity rubbers and to maximize the viscosity of the styrene-acrylonitrile (SAN) copolymer formed during the reaction.

In the literature, there are various technical solutions for the synthesis of acrylonitrile-butadiene-styrene (ABS) copolymers through continuous mass polymerisation processes with rubber particles having an average volumetric diameter of the particles of less than 0.5 μm, which provide for the maximisation of the grafting reaction combined with the use of low-viscosity rubbers.

It is in fact known that the use of difunctional radical polymerisation initiators at temperatures below 115° C., in the early stages of the polymerisation reaction, produces both an increase in styrene-acrylonitrile (SAN) copolymer grafted onto polybutadiene and a high molecular mass of the styrene-acrylonitrile (SAN) copolymer phase. For concentrations of low weight average molecular weight (M_{w}) polybutadiene greater than 9% in the initial reaction mixture and high weight average molecular weight (M_{w}) of the styrene-acrylonitrile (SAN) copolymer formed before the phase inversion, however, the conditions of partial crosslinking of the elastomeric phase (i.e. the rubber particles) are met, since a polymeric chain of styrene-acrylonitrile (SAN) copolymer can be grafted to two polymeric chains of polybutadiene of two distinct rubber particles.

For example, U.S. Pat. No. 5,414,045 relates to a composition obtained by means of a continuous mass polymerisation process by reaction of a continuous phase comprising a vinyl aromatic monomer, an unsaturated nitrile monomer and a diene polymeric rubber dissolved in said monomer, said composition comprising a graft copolymer and a free rubber copolymer, said graft copolymer comprising a diene rubber substrate with a vinyl aromatic/unsaturated nitrile copolymer grafted to said substrate, said rubber substrate having an average particle diameter of less than 0.3 μm, said rubber substrate having both internal and external surfaces and having a cell morphology defined as a network of rubber membranes having a spherical surface containing occlusions of vinyl aromatic/unsaturated nitrile copolymer within the rubber substrate, said vinyl aromatic/nitrile copolymer unsaturated being grafted into both surfaces inside and outside of the rubber substrate in which said composition has a gloss measured with a “Grader Gloss Meter” greater than 90%, at 60°. The polymerisation reaction is carried out in a plug flow reactor (PFR) and the reaction mixture leaving said reactor is fed to a continuous stirred tank reactor (CSTR) having a content of vinyl aromatic/unsaturated nitrile copolymer higher than that necessary to complete the phase inversion.

U.S. Pat. No. 7,132,474 relates to a continuous mass process for the preparation of an acrylonitrile-butadiene-styrene (ABS) copolymer comprising the following steps: a) preparing a solution containing styrene monomers and acrylonitrile monomers by adding 5% by weight-10% by weight of a mixture of styrene monomers and acrylic monomers in a reaction solvent; b) preparing a polymerisation solution by dissolving a butadiene rubber in said solution containing styrene monomers and acrylonitrile monomers; c) polymerize by means of a serial injections of the solution prepared in step b) and an initiator in a grafting reactor; polymerizing the reaction mixture obtained in step c) by adding 90% by weight-95% by weight with respect to the total weight of the reaction mixture of styrene monomers and acrylic monomers in a phase inversion reactor; and e) further polymerize the reaction mixture obtained in step d) at 130° C.-160° C. The aforementioned composition is said to have excellent impact resistance and excellent gloss.

However, the aforementioned processes are complex and involve the use of continuous stirred tank reactors (CSTR), generally not recommended in the production of acrylonitrile-butadiene-styrene (ABS) copolymers because they require frequent cleaning and do not guarantee the quality of the final product.

Another way to increase the concentration of grafted polymer in the production of rubber-reinforced styrene (co)polymers, for example, high impact polystyrene (HIPS), through continuous mass processes, is to use di-block rubbers.

In the production of high impact polystyrene (HIPS) it is known, in fact, to feed a styrene-polybutadiene block polymer containing a percentage of polybutadiene of 60% by weight with respect to the total weight of the polymer, in order to obtain rubber particles in the elastomeric phase with capsule morphology (mono-occlusion) having an average volumetric diameter of less than 0.5 μm and high gloss. Unfortunately, in the synthesis of acrylonitrile-butadiene-styrene (ABS) copolymers, the use of polybutadiene-styrene-acrylonitrile block copolymers (polybutadiene-SAN) is not possible as acrylonitrile does not polymerize anionically.

However, in the known art processes are reported in which the formation of the grafted copolymer polybutadiene-styrene-acrylonitrile (polybutadiene-SAN) is emphasised and promoted “in situ” during the polymerisation process of the polybutadiene, styrene and acrylonitrile mixture. In order to emphasize the reaction between polybutadiene and the mixture of styrene and acrylonitrile monomers, rubbers are used which contain in their molecular structure an active radical site capable of activating at the temperature used in the radical polymerisation process.

For example, the EP patent 1,592,722 relates to a mass/solution process that uses a functionalised rubber to produce a polymer rubber modified with a vinyl aromatic monomer comprising polymerizing the vinyl aromatic monomer by means of a linear process, using one or more polymerisation reactors, in presence of a rubber, wherein the rubber comprises a functionalised styrene-butadiene block copolymer having: a) a solution viscosity (5% in styrene at 20° C.) from 5 cps to less than 50 cps; and b) at least one functional group per rubber polymer chain capable of controlling radical polymerisation so that the grafted rubber particles are formed and dispersed in the matrix comprising the polymerised vinyl aromatic monomer and have a wide singlemode size distribution and in which the rubber is present in an amount between 5% by weight and 25% by weight with respect to the total weight of the polymerisation mixture. The modified polymeric rubber thus obtained is said to have a high gloss and a high hardness.

U.S. Pat. No. 7,115,684 relates to a rubber modified polymeric composition obtained by continuous mass polymerisation comprising: a matrix consisting of a continuous phase comprising a polymer of a monovinylidene aromatic monomer and, optionally, an ethylenically unsaturated nitrile monomer, and particles of discrete rubber dispersed in said matrix, said rubber particles being produced from a rubber component comprising from 5% by weight to 10% by weight of a functionalised diene rubber having at least one functional group per rubber polymer chain capable of controlling radical polymerisation; wherein the composition is further characterised by: a) an average volumetric diameter of the rubber particles of from approximately 0.15 μm to 0.35 μm; a total volume of the rubber phase from 12% by weight to 45% by weight with respect to the total weight of the matrix and the rubber particles; c) a partial volume of the rubber phase between 2% and 20% characterised by rubber particles having an average volumetric diameter greater than 0.40 μm; and d) a cross-linked rubber fraction of at least 85% by weight with respect to the total weight of the rubber particles. The aforementioned composition is said to have high gloss and high gloss sensitivity, whilst maintaining good hardness properties.

In the EP patent 1,592,722 and in the U.S. Pat. No. 7,115,684 reported above, the rubbers functionalised with at least one functional group per rubber polymer chain capable of promoting the formation of a grafted copolymer, are obtained by anionic polymerisation of polybutadiene and styrene. The termination reaction of the anionic reaction is carried out with a compound containing a nitroxyl functional group (i.e., an organic compound that includes a nitrogen-oxygen bond) so that the styrene-butadiene rubber (SBR) contains that group as a polymer chain terminal. When said rubbers are used in the continuous mass polymerisation process for the production of the acrylonitrile-butadiene-styrene (ABS) copolymer, the nitroxyl functional group dissociates generating a terminal radical site on the styrene-butadiene rubber chains (SBR) capable of to react with the styrene and acrylonitrile monomers to form, “in situ”, a grafted polybutadiene-styrene-acrylonitrile copolymer (polybutadiene-SAN). The description of the synthesis process of rubbers terminated with a polymeric chain terminal containing a nitroxyl group is described, for example, in the U.S. Pat. No. 5,721,320 cited in the EP patent 1,592,722 and in the U.S. Pat. No. 7,115,684 reported above.

However, the industrial application of the EP patent 1,592,722 and of the U.S. Pat. No. 7,115,684 reported above, is limited by the commercial unavailability of the functionalised rubbers. Furthermore, in order to minimize the viscosity ratio between the polybutadiene phase and the styrene-acrylonitrile (SAN) matrix (which is the other fundamental parameter for obtaining rubber particles having an average volumetric diameter of less than 0.5 μm) in said patents functionalised styrene-butadiene block copolymers are used. This need derives precisely from the process used in said patents which in fact provides for the preparation of a solution of rubber in the mixture of monomers which must be subjected to the polymerisation process. Industrially, the preparation of this mixture requires that the polybutadiene must be subjected to the process of dissolution in the mixture of monomers: it is therefore necessary that the polybutadiene must be produced, then subjected to the finishing process (phase in which the solvent in which it is been synthesised is removed) and then subsequently ground to be subjected to the dissolution process. When the viscosity of the rubber is particularly low, such as that described in the aforementioned patents, the finishing step and the subsequent grinding step are technologically difficult if not impossible. Hence the need to structurally modify the rubbers by inserting a block of polystyrene in the polymeric chain in order to increase the consistency of the rubber itself and allow the finishing phase and subsequent grinding.

However, as described in U.S. Pat. No. 5,721,320 reported above, the use of styrene-butadiene rubbers (SBR) in the synthesis of acrylonitrile-butadiene-styrene (ABS) copolymers is economically disadvantageous for two reasons: the intrinsic cost of styrene-butadiene rubbers (SBR) and because it is forced to feed more styrene-butadiene rubber (SBR), compared with a polybutadiene rubber, in the production process of acrylonitrile-butadiene-styrene (ABS) copolymers. In fact, the properties of acrylonitrile-butadiene-styrene (ABS) copolymers depend on the concentration of polybutadiene in the final product: since in the styrene-butadiene block rubber (SBR) the polybutadiene content is less than 100%, it is necessary to feed more styrene-butadiene (SBR) rubber blocks to achieve the desired polybutadiene concentration in acrylonitrile-butadiene-styrene (ABS) copolymers. Lastly, it is necessary to take into consideration the fact that, if there is a need to adjust the amount of grafted copolymer generated “in situ” from the use of said rubbers, it is necessary to provide for the mixing of functionalised styrene-butadiene rubbers (SBR) with not functionalised rubbers. In fact, as reported in the aforesaid patents EP 1,592,722 and U.S. Pat. No. 7,115,684, the functionalised rubbers must contain at least one functional group per rubber polymeric chain. If the amount of graft copolymer that is formed using a functionalised rubber in this way is excessive, it is necessary (as also mentioned in the examples of the aforementioned patents) to decrease the concentration of active sites in the reaction mixture by adding not functionalised rubbers that are in such a way that, on average, the rubber chains contain a number of active sites lower than one. The use of two rubbers involves the complication of the production process and an increase in production costs.

Other processes are also known which are useful for obtaining polymers functionalised with nitroxyl groups capable of promoting the subsequent grafting reaction.

For example, U.S. Pat. No. 6,525,151 relates to a process for the preparation of a grafted polymer in which in the first step A) a stable nitroxyl radical is grafted into the polymer, said step comprising heating the polymer and the stable nitroxyl radical (NO.) at a temperature between 150° C. and 300° C. in a reactor suitable for mixing the molten polymer; and in the second step B) the grafted polymer of step A) is heated in the presence of an ethylenically unsaturated monomer or oligomer to a temperature in which the cleavage of the nitroxyl-polymer bond takes place and the polymerisation of the ethylenically unsaturated monomer or oligomer on the polymer radical is initiated; maintaining said temperature to continue polymerisation and subsequently cooling to a temperature below 60° C.

The functionalisation process described in the aforementioned U.S. Pat. No. 6,525,151 is very effective and also allows to adjust at will the amount of nitroxyl bonds that are formed for a single rubber polymeric chain. In the event that there is a need to use polybutadiene polymer chains containing less than one active site per polymer chain, one is therefore not forced to use two rubbers (one functionalised and one non-functionalised). The functionalisation process described in the aforementioned patent, however, provides that the functionalisation reaction is carried out on the melted polymer: on an industrial level, this involves an additional processing and, therefore, an increase in costs, compared to the standard process.

U.S. Pat. No. 6,335,401 relates to grafted copolymers containing a grafted group having general formula (I):

—O-PM₁-(PM₂)-T (I)
wherein:
   PM₁ represents a polymeric block obtained from the radical (co)polymerisation of at least one monomer M₁;
   PM₂, optionally present, represents a polymeric block obtained from the (co)polymerisation by radical way of at least one monomer M₂; and
   T represents a residue of a stable radical T*.

Said (co)polymers are synthesised starting from a polymer (for example, polyethylene) reacted with ozone and then grown with a monomer (for example, styrene) in the presence of stable nitroxyl radicals. However, even this process, although extremely effective, is of difficult industrial application.

Further processes, in solution, useful in order to obtain functionalised polymers with nitroxyl groups capable of promoting the subsequent grafting reaction, are known.

For example, U.S. Pat. No. 6,255,402 relates to a process for the synthesis of a functionalised rubber, in particular, high impact polystyrene (HIPS) with a group that generates stable free radicals (for example, a nitroxyl group), comprising the heat treatment of an elastomer in the presence of a stable free radical, of a free radical initiator which is capable of extracting a proton from the elastomer and of a solvent and in the absence of a vinyl aromatic monomer, so that the rubber is functionalised, on average, with 0.1 to 10 functional groups capable of generating stable free radicals per rubber polymeric chain. The functionalised rubber thus obtained, for example polybutadiene functionalised with nitroxyl groups, is subsequently subjected to radical polymerisation in the presence of a vinyl aromatic monomer, for example styrene, so as to form “in situ” a grafted polybutadiene-polystyrene copolymer. The functionalisation reaction is carried out by dissolving the polybutadiene in the diluent used in the subsequent synthesis of high impact polystyrene (HIPS) (normally, ethylbenzene), in the presence of a radical initiator and a compound containing a stable free nitroxyl radical. The reaction mixture thus prepared is heated to a temperature sufficient to favour the dissociation of the radical initiator. The functionalised rubber solution in the diluent, after addition of styrene and additives, is subjected to the radical polymerisation process in order to obtain the final high impact polystyrene (HIPS). The final properties of high impact polystyrene (HIPS), in terms of balance of mechanical and aesthetic properties, are changed by modifying the amounts of the radical initiator/stable free nitroxyl radical system in the functionalisation reaction of the rubber in the diluent.

The functionalisation reaction of polybutadiene in solution is an effective technique and also allows to adjust at will the amount of nitroxyl functional groups generated for a single polymeric rubber chain by reaction between the stable free nitroxyl radicals and polybutadiene. In the event that there is a need to use polybutadiene containing less than one active site per rubber polymeric chain, one is therefore not forced to use two rubbers (one functionalised and one non-functionalised). However, said process also has a drawback due to the maximum amount of polybutadiene that can be reached in the final polymer. In the examples reported in the aforementioned U.S. Pat. No. 6,255,402, in fact, the functionalisation reaction of the rubber is carried out by preparing a dissolution of polybutadiene in a diluent at 20% by weight. The subsequent addition of styrene causes the concentration of polybutadiene in reaction to be 6%, while the amount of diluent in reaction is 24%. These amounts of reagents are compatible with the synthesis of high impact polystyrene (HIPS) but are not compatible with those of acrylonitrile-butadiene-styrene (ABS) copolymers. In fact, the minimum concentration of rubber in the acrylonitrile-butadiene-styrene (ABS) copolymers having a high mechanical strength/aesthetic properties balance must be at least 13%. Assuming the use of the same amount of diluent (24%), the polybutadiene concentration in the dissolution/functionalisation phase of the rubber should be at least 40%. This rubber concentration is not technologically manageable in a continuous mass production plant due to the high viscosity of the rubber solution in the diluent. In addition, a concentration of diluent in reaction of 24% leads to a reduction in the production capacity of the plant itself with a consequent increase in production costs.

Also known are processes for the production of rubber-reinforced styrene polymers in the presence of stable free nitroxyl radicals without any functionalisation reaction. In this case, however, broad distributions of the average volumetric diameter of the rubber particles are always obtained.

For example, U.S. Pat. No. 6,262,179 relates to a process for producing a composition comprising a matrix comprising a vinyl aromatic polymer or copolymer in which rubber particles are dispersed, said process comprising a polymerisation step in the presence of at least one vinyl aromatic monomer and of at least one rubber during which a phase inversion occurs which results in the formation of rubber particles, said polymerisation being initiated thermally or by means of a polymerisation initiator, characterised in that a stable free radical (for example, a nitroxyl radical) is present during the polymerisation step in an amount of at least 10 ppm with respect to the total amount of vinyl aromatic monomer (for example, styrene) and that the size distribution of the rubber particles is broad compared to when the stable free radical is not present. In this way, a broad size distribution of the rubber particles is obtained, said rubber particles having an average size always higher than that necessary to guarantee the properties of acrylonitrile-butadiene-styrene (ABS) copolymers a (i.e. lower than or equal to 0.5 μm).

U.S. Pat. No. 6,815,500 relates to a process for the preparation of a composition comprising a vinyl aromatic polymer matrix which includes rubber particles, comprising a polymerisation step of at least one vinyl aromatic monomer in the presence of a rubber, a polymerisation initiator and a stable free radical, said step being such that the ratio:

[F_{SFR}x(SFR)]:[F_{AMD}x(AMO)]

is in the range of 0.05 to 1, wherein F_{FSR} and F_{AMO} represent the functionality of the stable free radical and radical initiator, respectively, and (SFR) and (AMO) represent the molar amounts of the stable free radical and the initiator radical, respectively. The above composition is said to be shock resistant and/or glossy. The aforementioned polymeric composition can comprise at least 90% of mono-occluded rubber particles (capsules) having an equivalent diameter between 0.1 μm and 1.0 μm. Alternatively, the aforementioned composition may also include “salami-like” particles with multi-occlusion and, preferably: 1) from 20% to 60% of the total area occupied by rubber particles consisting of rubber particles having an equivalent diameter between 0.1 μm and 1.0 μm; 2) from 5% to 20% of the total area occupied by rubber particles consisting of rubber particles having an equivalent diameter between 1.0 μm and 1.6 μm; e 3) from 20% to 75% of the total area occupied by the rubber particles consisting of rubber particles having an equivalent diameter greater than 1.6 μm. In all these cases, the size of the rubber particles is not suitable to guarantee the balance of mechanical and aesthetic properties of the acrylonitrile-butadiene-styrene (ABS) copolymers obtained.

The rubber functionalisation reaction can also be carried out in a solution containing diluent and monomer in the presence of a radical initiator and stable free nitroxyl radicals, as described, for example, in patent applications WO 2005/100425 and WO 2006/063719, in order to decrease the rubber concentration at this step of the process. However, even in this case, the maximum concentration of polybutadiene obtainable in the final products is compatible with the synthesis of high impact polystyrene (HIPS) but is not compatible with the synthesis of acrylonitrile-butadiene-styrene (ABS) copolymers.

The rubber functionalisation reaction can also be carried out directly downstream of the anionic polymerisation reaction of butadiene by promoting the termination reaction of the polybutadiene chains with a bromoalkane and a stable free nitroxyl radical as described, for example, in the patent application WO 2010/020374. Even in this case, however, the limit is set by the maximum concentration of polybutadiene obtainable in the final product which is not compatible with the synthesis of acrylonitrile-butadiene-styrene (ABS) copolymers.

Since rubber-reinforced vinyl aromatic (co)polymers, in particular acrylonitrile-butadiene-styrene (ABS) copolymers, which have high aesthetic properties and high mechanical properties are still of great interest, the study of new rubber-reinforced vinyl (co)polymers is still of great interest.

### SUMMARY

The Applicant therefore posed the problem of finding new rubber-reinforced vinyl aromatic (co)polymers, in particular acrylonitrile-butadiene-styrene (ABS) copolymers, which have high aesthetic properties, in particular in terms of gloss and gloss sensitivity, and mechanical properties, in particular in terms of impact resistance and puncture resistance.

The Applicant has now found a rubber-reinforced vinyl aromatic (co)polymer comprising: (a) a polymeric matrix comprising at least one vinyl aromatic monomer and at least one comonomer; (b) rubber particles obtained by means of a continuous mass process from functionalised low cis polybutadiene rubber (LCBR) dispersed therein, having specific characteristics in terms of size and morphology.

The aforementioned rubber-reinforced vinyl aromatic (co)polymer has high aesthetic properties, in particular in terms of gloss and gloss sensitivity, and mechanical properties, in particular in terms of impact resistance and puncture resistance.

The aforementioned rubber-reinforced vinyl aromatic (co)polymer can be advantageously used in various applications, for example, injection moulding.

Therefore, the subject of the present disclosure is a rubber-reinforced vinyl aromatic (co)polymer comprising:
(a) a polymeric matrix comprising at least one vinyl aromatic monomer and at least one comonomer;
(b) rubber particles obtained by means of a continuous mass process from functionalised low cis polybutadiene rubber (LCBR) dispersed therein, characterised by the fact that:
   (i) the average volumetric diameter of said rubber particles is between 0.25 μm and 0.37 μm, preferably between 0.26 μm and 0.36 μm, more preferably between 0.27 μm and 0.35 μm;
   (ii) the volume of said rubber particles having a diameter greater than 0.40 μm is between 20% and 50%, preferably between 25% and 45%, more preferably between 30% and 40%, with respect to the total volume of the dispersed rubber particles;
   (iii) the ratio between rubber particles containing occlusions and rubber particles without occlusions (Particles containing occlusions/Particles without occlusions) is between 0.9 and 1.9, preferably between 1.0 and 1.8, more preferably between 1.2 and 1.7.

For the purpose of the present description and of the following claims, the definitions of the numerical ranges always include the extremes unless otherwise specified.

For purposes of the present description and of the following claims, the term “comprising” also includes the terms “which essentially consists of” or “which consists of”.

According to a preferred embodiment of the present disclosure, said vinyl aromatic monomer can be selected, for example, from the vinyl aromatic monomers having general formula (I):

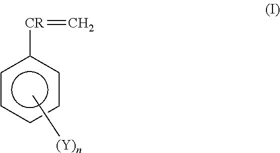

wherein R is a hydrogen atom or a methyl group, n is zero or an integer between 1 and 5, Y is a halogen atom such as, for example, chlorine, bromine, or an alkyl or alkoxy group having from 1 to 4 carbon atoms.

According to a preferred embodiment of the present disclosure, said vinyl aromatic monomer having general formula (I) can be selected, for example, from: styrene, α-methylstyrene, methylstyrene, ethylstyrene, butylstyrene, dimethylstyrene, mono-, di-, tri-, tetra- and penta-chlorostyrene, bromo-styrene, methoxy-styrene, acetoxy-styrene, or mixtures thereof. Styrene, α-methylstyrene, are preferred.

For the purpose of the present disclosure, the vinyl aromatic monomers having general formula (I) can be used alone or in mixture up to 50% by weight with other copolymerizable monomers.

According to a preferred embodiment of the present disclosure, said comonomer can be selected, for example, from: (meth)acrylic acid; C₁-C₄ alkyl esters of (meth)acrylic acid such as, for example, methylacrylate, methylmethacrylate, ethylacrylate, ethylmethacrylate, iso-propyl acrylate, butyl acrylate; amides and nitriles of (meth)acrylic acid such as, for example, acrylamide, methacrylamide, acrylonitrile, methacrylonitrile; imides such as, for example, N-phenyl maleimide; divinylaromatic monomers such as, for example, divinylbenzene; anhydrides such as, for example, maleic anhydride; or mixtures thereof. Acrylonitrile, methyl methacrylate, are preferred.

According to a preferred embodiment of the present disclosure, in said rubber-reinforced vinyl aromatic (co)polymer the polymer matrix comprising at least one vinyl aromatic monomer and at least one comonomer, has a weight average molecular weight (M_{w}) less than or equal to 145000 g/mole, preferably less than or equal to 140000 g/mole, more preferably between 90000 g/mole and 135000 g/mole.

According to a preferred embodiment of the present disclosure, in said rubber-reinforced vinyl aromatic (co)polymer the functionalised low cis polybutadiene rubber (LCBR) is present in an amount between 5% by weight and 35% by weight, preferably between 8% by weight and 30% by weight, more preferably between 10% by weight and 25% by weight, with respect to the total weight of the rubber-reinforced vinyl aromatic (co)polymer.

According to a preferred embodiment of the present disclosure, in said rubber-reinforced vinyl aromatic (co)polymer the rubber particles obtained by means of a continuous mass process from functionalised low cis polybutadiene rubber (LCBR), are obtained from a functionalised low cis polybutadiene rubber (LCBR) having the following characteristics:
weight average molecular weight (M_{w}) between 40000 g/mole and 110000 g/mole, preferably between 50000 g/mole and 100000 g/mole, even more preferably between 55000 g/mole and 95000 g/mole;
polydispersity index (PDI), i.e. the ratio between the weight average molecular weight (M_{w}) and the number average molecular weight (Mₙ) (M_{w}/Mₙ), less than or equal to 1.4, preferably less than or equal to 1.3, more preferably less than or equal to 1.2;
isomeric composition of the double bonds in the rubber chains (microstructure): content of 1,4-cis units between 10% by weight and 70% by weight, preferably between 20% by weight and 60% by weight, more preferably between 30% by weight and 50% by weight; content of 1,4-trans units between 20% by weight and 80% by weight, preferably between 30% by weight and 70% by weight, more preferably between 40% by weight and 60% by weight; 1,2-vinyl unit content between 0% by weight and 25% by weight, preferably between 0% by weight and 20% by weight; more preferably between 5% by weight and 15% by weight;
said low cis polybutadiene rubber (LCBR) being functionalised with a functional group capable of promoting controlled-chain radical polymerisation mediated by stable free nitroxyl radicals; and said low cis polybutadiene rubber (LCBR) having a number of functional groups per rubber polymer chain less than or equal to 1, preferably between 0.05 and 1, more preferably between 0.2 and 0.8, even more preferably between 0.3 and 0.7.

According to a preferred embodiment of the present disclosure, in said rubber-reinforced vinyl aromatic (co)polymer:
the weight average molecular weight (M_{w}) of the free functionalised low cis polybutadiene rubber (LCBR) is between 8000 g/mole and 70000 g/mole, preferably between 10000 g/mole and 60000 g/mole, more preferably between 15000 g/mole and 50000 g/mole;
the polydispersity index (PDI), that is the ratio between the weight average molecular weight (M_{w}) and the number average molecular weight (Mₙ) (M_{w}/Mₙ), of free functionalised low cis polybutadiene rubber (LCBR) is greater than or equal to 1.3, preferably greater than or equal to 1.4, more preferably greater than or equal to 1.5;
the isomeric composition of the double bonds of free functionalised low cis polybutadiene rubber (LCBR) (microstructure) is: content of 1,4-cis units between 10% by weight and 70% by weight, preferably between 20% by weight and 60% by weight, more preferably between 30% by weight and 50% by weight; content of 1,4-trans units between 20% by weight and 80% by weight, preferably between 30% by weight and 70% by weight, more preferably between 40% by weight and 60% by weight; 1,2-vinyl unit content between 0% by weight and 25% by weight, preferably between 0% by weight and 20% by weight; more preferably between 5% by weight and 15% by weight.

According to a preferred embodiment of the present disclosure, in said rubber-reinforced vinyl aromatic (co)polymer, the weight average molecular weight (M_{w}) of the free functionalised low cis polybutadiene rubber (LCBR) (M_{w} LCBR_{I}, expressed in g/mole), the average volumetric diameter of the rubber particles (Dᵥₘ, expressed in μm), the volume of rubber particles with a diameter greater than 0.40 μm (% Particles_{>0.4 μm}), the ratio of rubber particles containing occlusions and rubber particles without occlusions (Ratio_{occluded Part./non-occluded Part.}) and the weight average molecular weight (M_{w}) of the polymer matrix (M_{w} SAN, expressed in g/mole), are linked by the following relation:

$$0.15 {μm}^{3} \leq \frac{{MwLCBR}_{l} * \frac{4}{3} * π * {( {D}_{vm} )}^{3} * \% {Particles}_{> 0.4 μ m} * NSG}{MwSAN * {Ratio}_{occluded Part . / non - occluded Part .}} \leq 0.75 {μm}^{3} ,$$

preferably:

$$0 , 20 {μm}^{3} \leq \frac{{MwLCBR}_{l} * \frac{4}{3} * π * {( {D}_{vm} )}^{3} * \% {Particle}_{> 0 , 4 μ m} * NSG}{MwSAN * {Ratio}_{occluded Part . / non - occluded Part .}} \leq 0 , 65 {μm}^{3} ,$$

more preferably:

$$0.25 {μm}^{3} \leq \frac{{MwLCBR}_{l} * \frac{4}{3} * π * {( {D}_{vm} )}^{3} * \% {Particle}_{> 0.4 μ m} * NSG}{MwSAN * {Ratio}_{occluded Part . / non - occluded Part .}} \leq 0.5 {μm}^{3} ,$$

π being equal to 3.14 and the term NSG being defined according to the following formula:

$$NSG = \frac{No . of moles of stable free radical initiator containing a free nitroxyl radical ( NO ) ( III )}{No . of moles of LCBR} .$$

According to a preferred embodiment of the present disclosure, said rubber-reinforced vinyl aromatic (co)polymer has the following properties:
a gloss value, measured at 20°, greater than or equal to 50, preferably greater than or equal to 55, even more preferably greater than or equal to 60;
a gloss sensitivity less than or equal to 0.7, preferably less than or equal to 0.6, more preferably less than or equal to 0.5;
an impact resistance, measured at 23° C., greater than or equal to 12 kJ/m², preferably greater than or equal to 14 kJ/m², more preferably greater than or equal to 16 kJ/m²;
a puncture resistance, calculated as the product of the displacement at break (expressed in mm) multiply by the energy at break (expressed in J) greater than or equal to 400 J*mm, preferably greater than or equal to 450 J*mm, more preferably greater than or equal to 500 J*mm.

As stated above, the present disclosure also relates to a process for the preparation of the rubber-reinforced vinyl aromatic (co)polymer reported above.

The present disclosure also provides a process for the preparation of a rubber-reinforced vinyl aromatic (co)polymer comprising the following steps:
(a) obtaining a functionalised low cis polybutadiene rubber (LCBR) with a weight average molecular weight (M_{w}) between 40000 g/mole and 110000 g/mole, preferably between 50000 g/mole and 100000 g/mole, even more preferably between 60000 g/mole and 95000 g/mole, in a low boiling solvent;
(b) discontinuously exchanging the low boiling solvent with a vinyl aromatic monomer;
€ storing the solution of functionalised low cis polybutadiene rubber (LCBR) in vinylaromatic monomer in a buffer tank, according to the functionalised low cis polybutadiene rubber (LCBR) grade obtained;
(d) feeding an aliquot of the solution of functionalised low cis polybutadiene rubber (LCBR) in vinylaromatic monomer stored in the buffer tank to a vessel and add a further aliquot of vinyl aromatic monomer to reach the desired concentration of rubber in the reaction mixture, at least one solvent, at least one radical polymerisation initiator, at least one chain transfer agent and further conventional additive €(e) continuously feeding the solution obtained in step (d) to a first plug flow reactor (PFR) (R1) and immediately before entering said first reactor (R1) feeding a stream containing at least one comonomer;
(f) continuously feeding the reaction mixture leaving said first reactor (R1) to a second plug flow reactor (PFR) (R2) to which it is also continuously fed a solution of at least one chain transfer agent in solvent;
(g) recovering the rubber-reinforced vinyl aromatic (co)polymer from the polymerisation plant;
characterised by the fact that the weight average molecular weight (M_{w}) of the functionalised low cis polyutadiene rubber (LCBR) (expressed in g/mole), the amount of chain transfer agent fed to the first plug flow reactor (PFR) (R1) €ep (e)](expressed in ppm, i.e. amount by weight of chain transfer agent fed with respect to the total weight of the compounds fed in sa€ [step (e)]) and the average volumetric diameter of the functionalised low cis polybutadiene rubber (LCBR) particles (expressed in μm) are linked by the following relation:

$$0.5 \frac{( g / moles ) * ppm}{{µm}^{3}} \leq \frac{( {M}_{w} ) LCBR * Chain transfer agent in R 1}{{( Average volumetric diameter of rubber particles )}^{3}} \leq 1.6 \frac{( g / {moles}^{s} ) * ppm}{{µm}^{3}} ,$$

preferably

$$0.55 \frac{( g / moles ) * ppm}{{µm}^{3}} \leq \frac{( {M}_{w} ) LCBR * Chain transfer agent in R 1}{{( Average volumetric diameter of rubber particles )}^{3}} \leq 1 , 5 \frac{( g / moles ) * ppm}{{µm}^{3}} ,$$

more preferably

$$0.6 \frac{( g / moles ) * ppm}{{µm}^{3}} \leq \frac{( {M}_{w} ) LCBR * Chain transfer agent in R 1}{{( Average volumetric diameter of rubber particles )}^{3}} \leq 1. \frac{( g / moles ) * ppm}{{µm}^{3}} .$$

It should be noted that in case the aforementioned relation:

$$\frac{( {M}_{w} ) LCBR * Chain transfer agent in R 1}{{( Average volumetric diameter of rubber particles )}^{3}}$$

has a value less than or equal to 0.5, a rubber-reinforced vinyl aromatic (co)polymer is obtained having low aesthetic properties, in particular in terms of gloss and gloss sensitivity and high mechanical properties, in particular in terms of impact resistance; vice versa, if the above ratio has a value greater than 1.6, a rubber-reinforced vinyl aromatic (co)polymer is obtained having high aesthetic properties, in particular in terms of gloss and gloss sensitivity and low mechanical properties, in particular in terms of impact resistance.

Step (a) of the aforementioned process to obtain the functionalised low cis polybutadiene rubber (LCBR) can be carried out as described in the art.

For this purpose, a poly(1,3-alkadiene), preferably 1,3-polybutadiene, is obtained by anionic radical polymerisation of at least one 1,3-alkadiene monomer, preferably 1,3-butadiene, in the presence of at least one aliphatic or cycloaliphatic low boiling solvent or a mixture thereof, and of at least one initiator, preferably a lithium alkyl.

In order to guarantee the properties of the functionalised low cis polybutadiene rubber (LCBR) useful for the purpose of the present disclosure, the aforementioned polymerisation is carried out in batch type reactors. In said type of reactors, the initiator, usually a primary or secondary lithium butyl, is added to the reaction mixture comprising at least one aliphatic or cycloaliphatic low boiling solvent (for example, cyclohexane) or a mixture thereof and at least one 1,3-alkadiene monomer, preferably 1,3-butadiene, in an amount such that, at the end of the polymerisation, the total amount of solids in the reaction mixture does not exceed 20% by weight with respect to the total weight of the reaction mixture.

It is also known that said polymerisation can be carried out in the presence of at least one Lewis base in a greater or lesser amount depending on the content of 1,2-vinyl units to be obtained in the polymer chain. Said Lewis base is generally selected from ethers or tertiary amines, in particular tetrahydrofuran (THF) which, already in an amount equal to 100 ppm on the solvent, is able to significantly accelerate the polymerisation reaction while maintaining the content of 1,2-vinyl unity at levels below 12% (in moles). In the presence of higher amounts of tetrahydrofuran (THF) the microstructure is progressively modified up to contents of 1,2-vinyl units higher than 40% [for example, for amounts of tetrahydrofuran (THF) equal to 5000 ppm]: high amounts of 1,2-vinyl units are, however, not necessary if not harmful, in the case of the use of the polymer, for example of polybutadiene, in the field of plastic material modification and, for this purpose, it is preferable that the content of said 1,2-vinyl units is less than or equal to 25%.

It is also known that the polymerisation reaction carried out in the absence of ethers or tertiary amines is fast enough to guarantee the complete polymerisation of the monomer in times not exceeding one hour with final temperatures not exceeding 120° C. and in any case regulated by the initial temperature of the reaction mixture that cannot be lower than 35° C.-40° C., under penalty of an insufficiently rapid onset reaction and incompatible with normal production cycles.

Carrying out the polymerisation in batch type reactors determines the formation of a polymer that has a monomodal molecular weight distribution in which the polydispersity index (PDI), that is the ratio between the weight average molecular weight (M_{w}) and the number average molecular weight (Mₙ) (M_{w}/Mₙ), is very close to 1 and is generally between 1 and 1.2, in any case not higher than 1.4.

The polymer obtained at the end of the polymerisation is a linear polymer and has the polymeric chain end groups still active, said end groups being constituted by the lithium-polyalkadienyl species (polybutadienyl in the case of the 1,3-butadiene monomer). The possible addition of a protogen agent (for example, an alcohol or a carboxylic acid) or a silicon aloderivative in which the ratio between the halogen and the silicon is equal to 1 [for example, trimethylchlorosilane (TMCS)], determines the termination of the lithium-butadienyl end group whilst preserving, at the same time, the linear macrostructure of the molecule.

Consequently, in order to deactivate the still active polymeric chain end groups, at least one terminating agent is usually added, preferably selected from compounds having general formula (I) or (II):

R¹—OH (I)

wherein R¹ represents a C₁-C₁₈ alkyl group;

R²—OH (II)

wherein R² represents a C₆-C₁₈ alkyl group.

At the end of the aforesaid polymerisation, a solution of low cis polybutadiene rubber (LCBR) in a low boiling aliphatic or cycloaliphatic solvent is obtained.

In order to functionalize said low cis polyutadiene rubber (LCBR), a catalytic polymerisation system is added to said solution consisting of at least one free radical initiator (G) with functionality F, capable of extracting a proton from the polymeric chain of the aforementioned polybutadiene rubber and at least one stable free radical initiator containing a free nitroxyl radical (NO.) (III), operating at molar ratios free nitroxyl radical (NO.) (III)/(G)*F lower than 4, preferably between 1 and 2, F being equal to the number of functional groups per molecule of free radical initiator (G) which, by decomposition, produces two free radicals.

The reaction mixture thus obtained is heated to a temperature such as to cause the dissociation of the radical initiator (G) to occur and is maintained at said temperature for the time necessary to ensure that at least 95% of stable free radical initiator containing a free nitroxyl radical (NO.) (III) is bound to the polymeric chains of said low cis polybutadiene rubber (LCBR).

For the purpose of the present disclosure, the number of moles of stable free radical initiator containing a free nitroxyl radical (NO.) (III) bound per low cis polyutadiene rubber (LCBR) defined as NSG is calculated according to the following formula:

$$NSG = \frac{\begin{matrix}No . of moles of stable free radical initiator \\ containing a free nitroxyl radical ( NO ) ( III )\end{matrix}}{No . of moles of LCBR}$$

it must be less than or equal to 1, preferably between 0.05 and 1, more preferably between 0.2 and 0.8, even more preferably between 0.3 and 0.7.

The free radical initiator (G) capable of extracting a proton from the polybutadiene rubber polymer chain can be selected, for example, from: azo-derivatives such as, for example, 4,4′-bis-(di-iso-butyron'trile), 4,4′-bis(4-cyanopentanoi' acid), 2,2′-azobis(2-amidinopropane)dihydrochloride, or mixtures thereof; peroxides; hydroperoxides; percarbonates; peresters; persals such as, for example, persulfates (for example, potassium persulfate, ammonium persulfate); or mixtures thereof. Preferably, the free radical initiator (G) is selected from peroxides such as, for example tert-butyl iso-propyl monoperoxycarbonate, tert-butyl 2-ethylhexyl monoperoxycarbonate, dicumyl peroxide, di-tert-butyl peroxide, 1,1-di(tert-butylperoxy) cyclohexane, 1,1-di(tert-butylperoxy)-3,3,5-trimethyl cyclohexane, tert-butylperoxyacetate, cumyl tert-butyl peroxide, tert-butyl peroxybenzoate, tert-butyl peroxy-2-ethylhexanoate, dibenzoyl peroxide, or mixtures thereof.

The stable free radical initiator containing a free nitroxyl radical (NO.) (III) can be selected from those having general formula (IIIa):

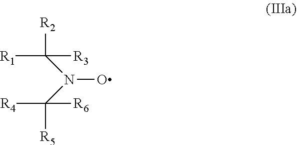

wherein:
R₁, R₂, R₅ and R₆, the same or different from each other, represent C₁-C₂₀ alkyl groups, linear or branched, substituted or unsubstituted, alkyl-(C₁-C₄)-aromatic groups;
R₃ and R₄, the same or different from each other, represent C₁-C₂₀ alkyl groups, linear or branched, substituted or unsubstituted, alkyl-(C₁-C₄)-aromatic groups, or R₃—CNC—R₄ can be part of a cyclic structure, for example with 4 or 5 carbon atoms, optionally fused with an aromatic ring or with a saturated ring containing from 3 to 20 carbon atoms.

Further details relating to the stable free radical initiators containing a free nitroxyl radical (NO.) (III), as well as to the process for their preparation, can be found, for example, in U.S. Pat. No. 4,581,429.

For the purpose of the present disclosure, preferably, the stable free radical initiator containing a nitroxyl radical (NO.) (III) is selected from 2,2,5,5-tetramethyl-1-pyrrolidinyloxy, 2,2,6,6-tetramethyl-1-piperidinyloxy (known under the trade name TEMPO), 4-hydroxy-2,2,6,6-tetramethyl-1-piperidinyloxy (known under the trade name 40H-TEMPO), 1,1,3,3-tetraethylisoindolin-2-oxy (known under the trade name TEDIO): further details relating to said stable free radical initiators containing a free nitroxyl radical (NO.) (III), as well as to the process for their preparation, can be found, for example, in patent application WO 2004/078720.

At the end of step (a), step (b) of exchange of the low boiling solvent with the vinyl aromatic monomer can be carried out as follows.

For this purpose, the low boiling solvent is removed and replaced with a vinyl aromatic monomer (for example, styrene) in order to maintain a final concentration of functionalised low cis polyutadiene rubber (LCBR) in styrene between 5% by weight and 45% by weight, preferably between 5% by weight and 40% by weight, more preferably between 5% by weight and 35% by weight, with respect to the total weight of the functionalised low cis polybutadiene rubber (LCBR) in styrene.

As reported above, in step (d), to the solution of functionalised low cis polybutadiene rubber (LCBR) in vinylaromatic monomer, obtained in step (b), after storage in a buffer tank [step (c)], a further aliquot of vinyl aromatic monomer is added to reach the desired concentration of rubber in the reaction mixture, at least one solvent, at least one radical polymerisation initiator, at least one chain transfer agent and further conventional additives.

The vinyl aromatic monomer (for example, styrene) can be selected from those reported above.

According to a preferred embodiment of the present disclosure, in said step (d) the solvent can be selected from aromatic solvents such as, for example, ethylbenzene, toluene, xylenes, or mixtures thereof; or from aliphatic solvents such as, for example, hexane, cyclohexane, or mixtures thereof; or mixtures thereof. Ethylbenzene is preferred.

According to a preferred embodiment of the present disclosure, in said step (d) said at least one radical initiator can be added in an amount between 0% by weight to 0.7% by weight, preferably between 0% by weight and 0.6% by weight, more preferably between 0.02% by weight and 0.5% by weight, with respect to the total weight of the reaction mixture.

According to a preferred embodiment of the present disclosure, in said step (d) said at least one radical initiator can be selected from those with an activation temperature between 40° C. and 170° C., preferably between 50° C. and 150° C., more preferably between 70° C. and 140° C. such as, for example, 4,4′-bis-(di-iso-butyron'trile), 4,4′-bis (4-cyanopentanoi' acid), 2,2′-azobis (2-amidinopropane) dihydrochloride; peroxides; hydroperoxides; percarbonates; peresters; or mixtures thereof. Preferably, said at least one radical initiator is selected from peroxides such as, for example, tert-butyl-iso-propyl monoperoxycarbonate, tert-butyl 2-ethylhexyl monoperoxy carbonate, dicumyl peroxide, di-tert-butyl peroxide, 1,1-di(tert-butylperoxy) cyclohexane, 1,1-di(tert-butylperoxy)-3,3,5-trimethyl cyclohexane (di-tert-butylperoxy cyclohexane), tert-butyl peroxyacetate, cumyl tert-butyl peroxide, tert-butyl peroxybenzoate, tert-butyl peroxy-2-ethylhexanoate, or mixtures thereof.

According to a preferred embodiment of the present disclosure, in said step (d) said at least one chain transfer agent can be added in an amount between 0.01% by weight and 1% by weight, preferably between 0.1% by weight and 0.8% by weight, more preferably between 0.15% by weight and 0.6% by weight, with respect to the total weight of the reaction mixture.

According to a preferred embodiment of the present disclosure, in said step (d) said at least one chain transfer agent can be selected, for example, from mercaptans such as, for example, n-octylmercaptan, n-dodecylmercaptan (NDM), tert-dodecylmercaptan, mercaptoethanol, or mixtures thereof n-Dodecylmercaptan (NDM) is preferred.

Further conventional additives that can be added in said step (d) can be selected, for example, from antioxidant agents, UV stabilizers, plasticizers, demoulding agents, athermans, flame retardants, blowing agents, antistatic agents, dyes, stabilizers, suitable and different depending on the applications of the obtained rubber-reinforced vinyl aromatic (co)polymer.

According to a preferred embodiment of the present disclosure, said step (d) can be carried out at a temperature between 30° C. and 90° C., preferably between 40° C. and 80° C.

According to a preferred embodiment of the present disclosure, i€aid step (e) said at least one comonomer can be added in an amount between 5% by weight and 35% by weight, preferably between 10% by weight and 30% by weight, more preferably between 17% by weight and 27% by weight, with respect to the total weight of the reaction mixture.

According to a preferred embodiment of the present disclos€, said step (e) can be carried out at a temperature between 100° C. and 130° C., preferably between 110° C. and 125° C.

In said step (f) said at least one chain transfer agent can be selected from those reported above.

According to a preferred embodiment of the present disclosure, in said step (f) said at least one chain transfer agent can be added in an amount between 0.5% by weight and 2.5% by weight, preferably between 0.7% by weight and 2.2% by weight, more preferably between 0.9% by weight and 2% by weight, with respect to the total weight of the reaction mixture.

According to a preferred embodiment of the present disclosure, said step (f) can be carried out at a temperature between 120° C. and 160° C., preferably between 130° C. and 155° C.

The process in the present disclosure can be advantageously carried out in a continuous mass polymerisation plant in order to obtain the desired rubber-reinforced vinyl aromatic (co)polymer: further details relating to said plant can be found, for example, in the EP patent 0400479.

### DETAILED DESCRIPTION OF THE DISCLOSURE

In order to better understand the present disclosure and to put it into practice, some illustrative and non-limiting examples are given below.

### EXAMPLES

The methods of analysis and characterisation reported below were used.

### a) Determination of the Molecular Weight Distribution (MWD)

The determination of the molecular weight distribution (MWD) was carried out by gel permeation chromatography (GPC), also known as size exclusion chromatography (SEC), carried out by flowing a solution in tetrahydrofuran (THF) of the (co)polymer to be analysed on a series of columns containing a solid phase consisting of cross-linked polystyrene with pores of different sizes.

The instrumentation used was composed of:
Waters 2695 injector pump system;
Waters 2414 differential refractive index detector (“detector R1”);
UV/Vis Waters 2489 detector.

The analysis was carried out on 4 Phenogel columns having a particle size of 5 μm and variable porosity: 10³, 10⁴, 10⁵ and 10⁶ A. The (co)polymer sample to be analysed was dissolved at least 5 hours in tetrahydrofuran (THF) to obtain a concentration of 1 mg/ml in the case of low cis polybutadiene rubber (LCBR) both functionalised and non-functionalised, and 2.5 mg/ml in the case of the free styrene-acrylonitrile (SAN) copolymer, and subsequently filtered on 0.45 μm polytetrafluoroethylene (PTFE) filters. The analysis was carried out with tetrahydrofuran (THF) as eluent at 1 ml/min.

The instrument was calibrated with 30 monodisperse polystyrene (PS) standards with weight average molecular weight (M_{w}) between 7000000 and 1000 Dalton.

To obtain the molecular weights of both functionalised and non-functionalised low cis polybutadiene rubber (LCBR) and of the free styrene-acrylonitrile (SAN) copolymer, reference is made to the theory of universal calibration through the equation of Mark-Houwink, using the constants shown in the following table:

| | K (dl/g) | a | References |
|---|---|---|---|
| Polystyrene | 1.6e⁻⁴ | 0.706 | (i) |
| LCBR | 4.57e⁻⁴ | 0.693 | (ii) |
| SAN (24% AN) | 1.46e⁻⁴ | 0.739 | (iii) |

### REFERENCES

(i) Mori S. and Barth, H. G. in “Size Exclusion Chromatography” (1999), pg. 199-229, Springer Ed.;
(ii) Evans J. M., in “Polymer Engineering and Science” (1973), Vol. 13(6), pg. 401-408;
(iii) Hamielec A. E., MacGregor J. F., Garcia Rubio, L. H. in “Advanced in Chemistry Series” (1963), Vol. 203, pg. 311-344.

The acquisition and processing of the chromatograms was obtained with Waters Empower 2 software. For the calculation of the molecular weights the chromatogram obtained with the detector R1 was used.

The weight average molecular weight (M_{w}) of the non-functionalised low cis polybutadiene rubber (LCBR) was determined on a sample of said rubber in cyclohexane taken after the termination reaction. The sample was dried (by gently removing the cyclohexane) and the dry residue was dissolved in tetrahydrofuran (THF) for at least 4 hours, at room temperature (25° C.), using toluene as an internal standard.

The weight average molecular weight (M_{w}) of the functionalised low cis polybutadiene rubber (LCBR) was determined on a sample of said rubber in cyclohexane taken after the functionalisation reaction. The sample was dried (by gently removing the cyclohexane) and the dry residue was dissolved in tetrahydrofuran (THF) for at least 4 hours, at room temperature (25° C.), using toluene as an internal standard.

The weight average molecular weight (M_{w}) of both functionalised and non-functionalised free low cis polybutadiene rubber (LCBR), in the obtained reinforced vinyl aromatic copolymer acrylonitrile-butadiene-styrene (ABS), was determined on the sample of said copolymer obtained by method f) Separation of both functionalised and non-functionalised free low cis polybutadiene rubber (LCBR) in the acrylonitrile-butadiene-styrene (ABS) copolymer reported below, dissolving said sample in tetrahydrofuran (THF) for at least 4 hours, at room temperature (25° C.), using toluene as an internal standard.

The weight average molecular weight (M_{w}) of the free styrene-acrylonitrile (SAN) copolymer was determined on the sample obtained by method e Determination of the swelling index of the acrylonitrile-butadiene-styrene (ABS) copolymer reported below, by dissolving the sample in tetrahydrofuran (THF) for at least 4 hours, at room temperature (25° C.), using toluene as an internal standard.

b) Determination of the Microstructure of Both Functionalised and Non-Functionalised Low Cis Polybutadiene Rubber (LCBR) and Determination of the Microstructure of Both Functionalised and Non-Functionalised Free Low Cis Polybutadiene Rubber (LCBR), in the Acrylonitrile-Butadiene-Styrene (ABS) Copolymer

The determination of the microstructure of both functionalised and non-functionalised low cis polybutadiene rubber (LCBR), and the determination of the microstructure of both functionalised and non-functionalised free low cis polybutadiene rubber (LCBR) in the acrylonitrile-butadiene-styrene (ABS) copolymer, was carried out by means of a Bruker Avance 300 MHz spectrometer, at a probe temperature of 300 K (26.85° C.).

The sample was prepared as follows: about 100 mg of sample were weighed on an analytical balance (samples that were obtained as described above) and were transferred into a borosilicate NMR tube (Wilmad®) with a diameter of 10 mm. Subsequently, approximately 3 ml of deuterated chloroform (CDCl₃) (Sigma-Aldrich 99.96 atom % D+TMS ˜0.1% v/v) was added obtaining a viscous suspension which was heated to 50° C. on a hot plate and maintained at said temperature for 2 hours, until complete dissolution.

A total of 2 NMR spectra were then recorded: one proton and one carbon-13 and the parameters for the acquisition are shown in the following table:

10 mm BBO 300 MHz S1 with z-gradient

| PROBE | ¹H - 300 MHz | ¹³C - 75 MHz |
|---|---|---|
| Method | zg30 | zgpg30 |
| No. of scans | 256 | 16k |
| (ns) | | |
| No data point | 64k | 32k |
| (TD) | | |
| p1 (μs) | 9.00 | 18.50 |
| d1 (s) | 7.0 | 3.0 |
| Spectral | 16 ppm | 239 ppm |
| window | | |
| O1P | 4.0 ppm | 100.0 ppm |

| | |
|---|---|
| Solvent | CDCl₃ 99.96 atom % D + TMS ~0.1% v/v |

The obtained FID was processed by means of a Fourier transform with zero filling correction (SI: 128 k). The ¹H-NMR spectrum was processed without FID apodisation (WDW: no), whilst the ¹³C-NMR spectrum was processed with exponential multiplication apodisation (WDW: EM) with a line broadening of 2.0 Hz.

Phase correction can be done automatically or manually, while the baseline can be optimised via the software algorithm. The chemical shift values refer to the singlet resonance of tetramethylsilane (TMS) at 0.000 ppm (both in the ¹H-NMR spectrum and in the ¹³C-NMR spectrum).

The determination of the complete microstructure on the sample of free low cis polybutadiene rubber (LCBR), both functionalised and non-functionalised, in the acrylonitrile-butadiene-styrene (ABS) copolymer, requires both the processing of the proton spectrum for the quantification in molar percentage of the 1,2 butadiene groups (1,2 vinyl unit) and 1,4 butadiene (1,4-cis unit and 1,4-trans unit), and of the ¹³C-NMR spectrum, the latter essential for the determination of the isomerism of the 1,4-cis and 1,4-trans units.

The processing of the ¹H-NMR spectrum was carried out according to ISO 21561-1:2015 standard (primarily applicable to styrene-butadiene polymers but adaptable to the microstructural analysis of polybutadiene only). In particular, by integrating the resonances at 4.97 ppm (signal specified with letter A in the formulas below reported: integration range from 4.80-5.15 ppm) and 5.42 ppm (signal indicated with letter B in the formulas below reported: integration range from 5.20-5.75 ppm), it is possible to calculate the total molar percentage distribution of the 1,2 butadiene (1,2 vinyl unit) and 1,4 butadiene (1,4-cis unit and 1,4-trans unit) groups by means of the formulas (1) and (2):

$${C}_{1 , 2 vinyl} mol \% = \frac{A / 2}{B / 2 + A / 4} \times 100 \qquad ( 1 )$$

$${C}_{1 , 4 total} mol \% = \frac{B / 2 - A / 4}{B / 2 + A / 4} \times 100. \qquad ( 2 )$$

The determination of the percentage of 1,4-cis units and 1,4-trans units was carried out by operating on the ¹³C-NMR spectra as reported in the literature by Sato H., Takebayashi K., Tanaka Y., in “Macromolecules” (1987), Vol. 20, pg. 2418-2423, using the relative integrations of the two signals referred to the methylene carbons next to the double bond in the cis configuration (at 24.90 ppm and at 27.42 ppm) and of the two signals referred to the methylene carbons next to the double bond in the trans configuration (at 30.15 ppm and at 32.71 ppm), according to the following formulas (3) and (4):

$${C}_{1 , 4 - cis} mol \% = \frac{{I}_{24.9 ppm} + {I}_{27.42 ppm}}{{I}_{24.9 ppm} + {I}_{27.42 ppm} + {I}_{30.15 ppm} + {I}_{32.71 ppm}} \times 100 \qquad ( 3 )$$

$${C}_{1 , 4 - cis} mol \% = \frac{{I}_{30.15 ppm} + {I}_{32.71 ppm}}{{I}_{24.9 ppm} + {I}_{27.42 ppm} + {I}_{30.15 ppm} + {I}_{32.71 ppm}} \times 100 \qquad ( 4 )$$

where the letter I indicates the value of the integral relating to the signal: the range of the integration, expressed in ppm, is indicated in the subscript.

### c) Determination of the Concentration of Low Cis Polybutadiene Rubber (LCBR), Both Functionalised and Non-Functionalised, in Styrene

The determination of the concentration of low cis butadiene rubber (LCBR), both functionalised and non-functionalised, in styrene obtained at the end of step (b) of the process in the present disclosure (exchange of the low-boiling non-polar solvent with styrene) was carried out thermogravimetrically using a Sartorius model MA50 thermobalance.

For this purpose, 3 g of low cis polybutadiene rubber (LCBR), both functionalised and non-functionalised, in styrene were placed in a previously calibrated container and heated to 200° C., for 30 minutes, to remove the styrene. Once cooled, the container with the dry residue was weighed and the percentage of low cis butadiene rubber (LCBR), both functionalised and non-functionalised, was determined by the ratio between the two weightings (dry/solution).

d) Determination of the concentration of low cis polybutadiene rubber (LCBR), both functionalised and non-functionalised, in the acrylonitrile-butadiene-styrene (ABS) copolymer The concentration of the functionalised low cis butadiene rubber (LCBR) in the acrylonitrile-butadiene-styrene (ABS) copolymer was determined by iodometric titration according to the method of Wys reported by Wys J. J. A., in “Berichte” (1898), Vol. 31, pg. 750-752.

### e) Determination of the Swelling Index

The crosslinking level of the rubber phase (i.e. rubber particles) in the acrylonitrile-butadiene-styrene (ABS) copolymer was measured by determining the swelling index value of the copolymer.

For this purpose, the following process was followed: two 50 ml steel tubes for centrifuge were prepared containing 0.5 g of acrylonitrile-butadiene-styrene (ABS) copolymer and 25 ml of acetone each: the tubes were left to stand overnight, at room temperature (25° C.) to have a complete dissolution. After mixing the solution with a rod, the volume was brought to about 30 ml with acetone and the whole was centrifuged for 20 minutes at 20000 rpm (45000 g) using a Sorvall Evolution RC laboratory supercentrifuge, with SA300 rotor. At the end of the centrifugation, the supernatant was decanted and stored for the analysis of the weight average molecular weight (M_{w}) of the free styrene-acrylonitrile copolymer as reported below.

Once the acetone was removed, the rubber phase, packed on the bottom of the tube, was diluted by adding 10 ml of tetrahydrofuran (THF), the volume was brought to about 30 ml with tetrahydrofuran (THF) and the whole was centrifuged for 20 minutes at 20000 rpm (45000 g) and the obtained supernatant was decanted.

At the same time, a crucible equipped with a dried porous filter gooch septum which was immersed for at least one hour in a vessel containing tetrahydrofuran (THF) was weighed (1st weight=P1): the level of tetrahydrofuran (THF) was at the height of the porous septum of the crucible and the vessel was kept in a closed container. Subsequently, the crucible was extracted, the solvent was dried on the glass walls without touching the wet porous septum, and the whole was quickly weighed (2nd weight=P2).

Using a spatula, the solid residue which was deposited on the porous septum of the crucible was recovered from the two test tubes without touching the walls and then dispersed in such a way as to completely cover the porous septum: everything was left to swell for 5 hours, in the vessel inside the closed container, at room temperature (25° C.). The crucible was extracted again, the solvent on the glass walls was dried without touching the wet porous septum or the solid deposited on it, and the whole was quickly weighed again (3rd weight=P3).

At this point, ethanol was added drop by drop to the solid residue present in the crucible until the crucible was completely filled and the whole was subjected to filtration. The solid residue remaining in the crucible was dried for 12 hours in an oven, under vacuum, at 40° C.: lastly the crucible with the dried gel was weighed (4th weight=P4).

The swelling index value was calculated according to the following formula (5):

$$IR = \frac{P 3 - P 2}{P 4 - P 1} . \qquad ( 5 )$$

The supernatant obtained after the first centrifugation was treated as follows: after having completely removed the acetone, the solid residue obtained was dissolved in the minimum amount of tetrahydrofuran (THF), re-precipitated in ethanol, subjected to filtration, dried in an oven, under vacuum, at 40° C., for 12 hours, and subsequently subjected to gel permeation chromatography (GPC), operating as described above in method a) Determination of the molecular weight distribution (MWD).

### f) Separation of Both Functionalised and Non-Functionalised Free Low Cis Polybutadiene Rubber (LCBR) in the Acrylonitrile-Butadiene-Styrene (ABS) Copolymer

The determination of the weight average molecular weight (M_{w}) and of the microstructure of the free (non-crosslinked) low cis polybutadiene rubber (LCBR), both functionalised and non-functionalised, in the acrylonitrile-butadiene-styrene (ABS) copolymer, was determined by modifying the process reported in the literature by Turner R. R., Carlson D. W., Altenau A. G., in “Journal of Elastomers and Plastics” (1974), Vol. 6, pg. 94-102.

For this purpose, eight 50 ml steel tubes for centrifuge were prepared containing 0.5 g of acrylonitrile-butadiene-styrene (ABS) copolymer and 25 ml of acetone each: the tubes were left to stand overnight, at room temperature (25° C.) to have a complete dissolution. After mixing the solution with a rod, the volume was brought to about 30 ml with acetone and the whole was centrifuged for 30 minutes at 20000 rpm (45000 g) using a Sorvall Evolution RC laboratory supercentrifuge, with SA300 rotor. At the end of the centrifugation the supernatant was decanted. Once the acetone was removed, the rubber phase, packed on the bottom of the tube, was diluted by adding 10 ml of acetone, the volume was brought to about 30 ml with acetone and the whole was centrifuged for 30 minutes at 20000 rpm (45000 g), and the supernatant obtained was decanted: the process was repeated twice. The solid residue deposited on the bottom of the tube (rubber phase) was recovered and placed in the thimble of a Kumagawa extractor. 200 ml of cyclohexane were added to the extractor and the whole was left to reflux for 24 hours. The cyclohexane solution was brought to dryness by evaporation of the cyclohexane and the solid residue obtained was subjected to gel permeation chromatography (GPC) operating as described above in method a) Determination of the molecular weight distribution (MWD) for the determination of the weight average molecular weight (M_{w}) and NMR analysis, operating as described above in the method reported in b) Determination of the microstructure of both functionalised and non-functionalised low cis polybutadiene rubber (LCBR) and determination of the microstructure of free low cis polybutadiene rubber (LCBR) both functionalised and non-functionalised, in the acrylonitrile-butadiene-styrene (ABS) copolymer.

### g) Transmission Electron Microscopy (TEM) and Image Analysis

The particle size of low cis polybutadiene rubber (LCBR) and the volume of the rubber phase were determined by means of transmission electron microscopy (TEM).

For this purpose, a sample (granule) of styrene-butadiene-acrylonitrile (ABS) copolymer was placed in a clamp and suitably trimmed to prepare a suitable surface for the subsequent ultra-thin cut. Subsequently, the sample was immersed in a 4% solution of osmium tetroxide (Os04) (Sigma-Aldrich) for about 48 hours (“staining”), at room temperature (25° C.). After this treatment, the sample has sufficient stiffness to be sectioned at room temperature (25° C.) by ultramicrotomy, obtaining sections with a thickness of approximately 120 nm (determined by the interference colour that the sections take on the water once cut), which were collected on a copper grid and observed with a transmission electron microscope TEM PHILIPS CM120 at 80 KV.

A series of images of the sample were then digitised at iso-magnification in order to obtain a statistically significant number of counted particles (usually around 1000). The images were analysed using the AnalySIS image analysis software: image analysis allows you to extract numerical parameters such as areas, perimeters, diameters, extinction, optical density, transmittance, topological parameters and similar from the images. It uses mathematical algorithms that make it possible to obtain information from the image once it has been reduced in numerical form by means of appropriate acquisition and processing systems. The image analysis for the numerical determination of the dispersed rubber phase was carried out as described in U.S. Pat. No. 7,115,684 (from column 11, row 22 to column 13, row 65). In particular, the value of the “Dispersity Factor I” reported in Table 2a-2d, was determined as described in the aforementioned U.S. Pat. No. 7,115,684, column 13, lines 54-60, whilst the average volumetric diameter of the rubber particles was determined as described in the aforesaid U.S. Pat. No. 7,115,684 in column 13, lines 35-30.

All the images and the apparent raw data have been stored and are available for any further processing of a stereological nature aimed at reconstructing distributions of real diameters and volume of the particles in the styrene-butadiene-acrylonitrile (ABS) copolymer sample.

h) Measure Ratio Between Rubber Particles Containing Occlusions/Rubber Particles without Occlusions

The ratio between rubber particles without occlusion [hereinafter referred to as balls] and rubber particles containing occlusions [hereinafter referred to as caps and “salami” ]presupposes a priori an overall count of the particles implemented by method g) Transmission Electron Microscopy (TEM) and image analysis reported above.

In particular, the following have been defined:
balls: rubber particles that do not contain any occlusion of the matrix inside;
caps: rubber particles in which a single matrix occlusion occupies an area equal to at least 85% of the total surface area of the particle itself;
“salami”: rubber particles containing two or more matrix occlusions; in this type of particles, no matrix occlusion occupies an area of more than 85% of the total surface of the particle itself.

Occlusions are identified as the surfaces inside the rubber particle having a lighter colour and whose area is at least 0.01 m².

In order to define the relationship between rubber particles without occlusion (balls) and rubber particles containing occlusions [caps and “salami” ], on the images obtained as described above, the types of particles with the morphology defined as described above were highlighted with different colours.

This analysis is also carried out on a statistically significant number of particles (usually around 1000). In the calculation phase, the software is able to process and carry out the analysis by single colour, calculating data, percentages and relative ratios for each type of identified particle. The percentage of the various types of particles is expressed with respect to the total of the analysed particles and expresses the number of a certain type of particles with respect to the total.

The ratio of particles containing occlusions and particles without occlusions is defined as follows:

$$Particles containing occulsions / Particles without occlusions = \frac{\% caps + \% {}^{″} {salami}^{″}}{\% balls} .$$

Also in this case, images and data are stored for any future processing.

### i) Melt Flow Index (MFI) Measurement

The Melt Flow Index (MFI) was measured according to ISO 1133-1:2011 standard, at 220° C., under a weight of 10 Kg.

### 1) IZOD Measurement (Impact Resistance)

The Izod value with notch (on injection moulded specimens according to ISO 294:1-2017 standard was determined according to ISO 180/1A-2020 with values expressed in kJ/m².

### m) Tensile Strength

The tensile strength properties (on injection moulded specimens according to ISO 294: 1-2017 standard were determined according to ISO 527-1:2019 standard with values expressed as shown below:

| | |
|---|---|
| elastic module: | MPa; |
| stress at yield : | MPa; |
| stress at break: | MPa; |
| elongation at yield: | %; |
| elongation at break: | %. |

### n) Gloss Measurement

The gloss of the styrene-butadiene-acrylonitrile (ABS) copolymer was determined according to standard ASTM D523-14:2018 standard at a reading angle of 20° using a BYG Gardner Model 4563 glossmeter.

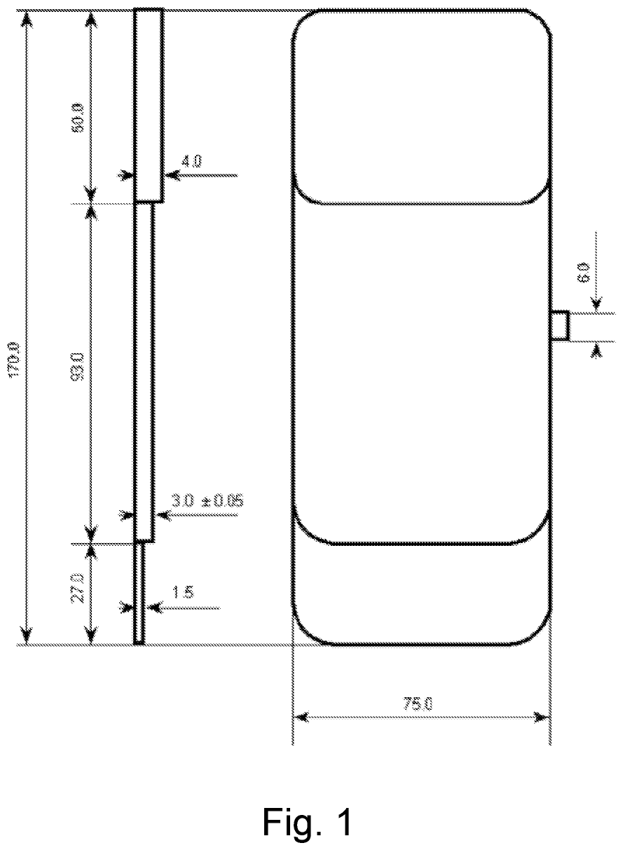

The measurement was carried out on “three-step” specimens (see FIG. 1 which shows the dimensions of the “three-step” plates for determining the gloss@20° of the obtained copolymer) obtained by injection moulding according to ISO 294:1-2017 standard using a Negri & Bossi model NB60 injection moulding machine. In particular, the measurement of the gloss was carried out in the central part of the plate (second step, with dimensions 93×75×3 mm) at the height of the injection point. The measured gloss value is the average reading value of at least 10 samples operating under the following conditions:
melting temperature: 240° C.;
moulding temperature: 25° C.

### o) Gloss Sensitivity Measurement

The determination of the gloss sensitivity was carried out according to ASTM D523-14:2018 standard at a reading angle of 20° using a GARD PLUS Model 4725 glossmeter.

The measurement was made on flat specimens with dimensions 60×60×3 mm obtained by injection moulding according to ISO 294-3:2002 standard using an ENGEL model ES 150/50 injection moulding machine.

The different point gloss values were measured (average values of at least 10 samples) at the centre of the printed plates under the following different operating conditions:
melting temperature: 240° C.;
injection speed: 100 mm/s or 300 mm/s;
moulding temperature: 30° C. or 60° C.

Once the injection speed was defined (for example 100 mm/s) 10 plates were moulded for the different temperatures of the mould (30° C. or 60° C.). The same operation was repeated by varying the injection speed. In this way, we define a matrix of 2×2 values according to the following formula (11):

$$( \begin{matrix}Gloss @ 20 {°}_{30 ° C .}^{100 mm / s} & Gloss @ 20 {°}_{30 ° C .}^{300 mm / s} \\ Gloss @ 20 {°}_{60 ° C .}^{100 mm / s} & Gloss @ 20 {°}_{60 ° C .}^{300 mm / s}\end{matrix} ) . \qquad ( 11 )$$

The gloss sensitivity value is defined according to the following formula (12):

$$Gloss Sensitivity = \frac{Gloss @ 20 {°}_{60 ° C .}^{300 mm / s} - Gloss @ 20 {°}_{30 ° C .}^{100 mm / s}}{Gloss @ 20 {°}_{30 ° C .}^{100 mm / s}} . \qquad ( 12 )$$

### p) Biaxial Flexure Measurement (Puncture Resistance)

The biaxial flexure measurement (puncture resistance) was carried out using an INSTRON model 4400 R universal testing machine (using Bluehill 2.35 control software) equipped with an upper mobile crosshead compliant with the ISO 7500-1:2018 standard: the universal testing machine was able to maintain a constant crosshead speed during the test equal to 50 mm/min with a tolerance of 10%. The universal testing machine was equipped with a punch having a semi-spherical head with a radius of curvature R=10 mm and a circular support with an external diameter equal to 148 mm for supporting the specimens. On the upper surface of the support there was a housing with a diameter equal to 85 mm concentric with the support: the housing was useful for keeping the specimen in the correct position. The circular support was also provided with a concentric hole with a diameter equal to 40 mm to allow the deformation of the specimen during the test. The punch was inserted and fixed into the mobile crosshead and the circular support was fastened to the base plate of the universal testing machine so that the vertical axis of the punch coincided with the vertical axis of the circular support.

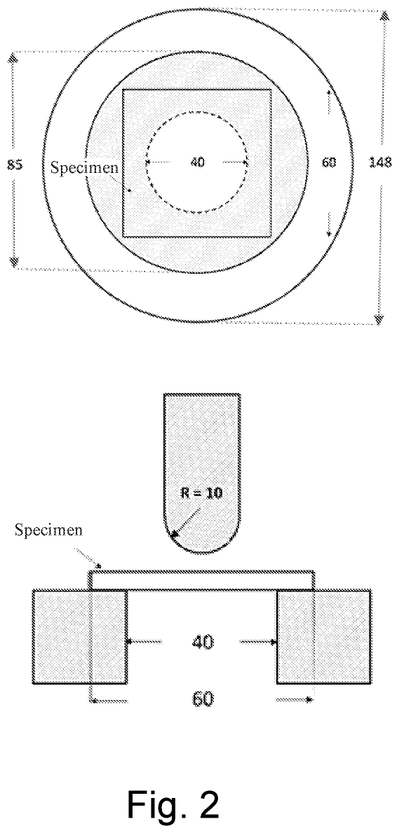

The geometry of the test used is illustrated in FIG. 2 which shows: below the side view, which shows the semi-spherical head punch; above the top view (dimensions in mm) (“Provino”=“specimen”). The biaxial flexure geometry described in FIG. 2 determined, during the test, an extremely complex stresses state in the specimen: in fact, by separating the stresses into the radial, circumferential and normal components (in a coordinate system with the origin at the centre of the specimen and the normal axis parallel to the specimen thickness), on the centre of the face opposite to the loading punch there was a biaxial traction, while on the centre of the face in contact with the punch there was a biaxial compression, moving towards the circular support an increase was found of the circumferential stress and a decrease of the radial one, which generated a state of shear stress. This complexity of the state of stress generated on the specimen has made it convenient to use isotropic specimens or specimens in which the state of molecular orientation (due, for example, to injection moulding) is as geometrically simple and controllable as possible, and possibly not very dependent on the thermal and rheological characteristics of materials. For this purpose, an injection molded test specimen was used consisting of a square plate of size 60×60×2 (mm) molded according to ISO 294-3:2002 standard. Injection molding conditions were selected according to ISO 19062-2:2019 standard: the specimen thus obtained was placed in the housing of the lower support so that the punch can penetrate it in its central part: the upper punch, fastened to the crosshead, moved at a speed of 50 mm/min. The universal testing machine software acquired and plotted the Force (N) vs displacement (mm) data and the following output parameters were obtained from each test run:
displacement at break (mm): value of the crosshead displacement corresponding to the point where the onset specimen break is detected (the onset of specimen break is detected when the drop in force measured between two successive acquisition points is equal to or greater than 20%);
strength at break (N): value of the force at the point where the onset of specimen break is detected (see above);
energy at break (J): value of the area subtended by the entire curve up to the onset of the break, it represents the energy to deform the specimen up to the onset of the break.

As reported above, the puncture resistance is calculated as the product of the displacement at break (expressed in mm) multiply by the energy at break (expressed in J), the unit of measurement being expressed in J*mm.

As stated above, the present disclosure also relates to a process for the preparation of the rubber-reinforced vinyl aromatic (co)polymer.

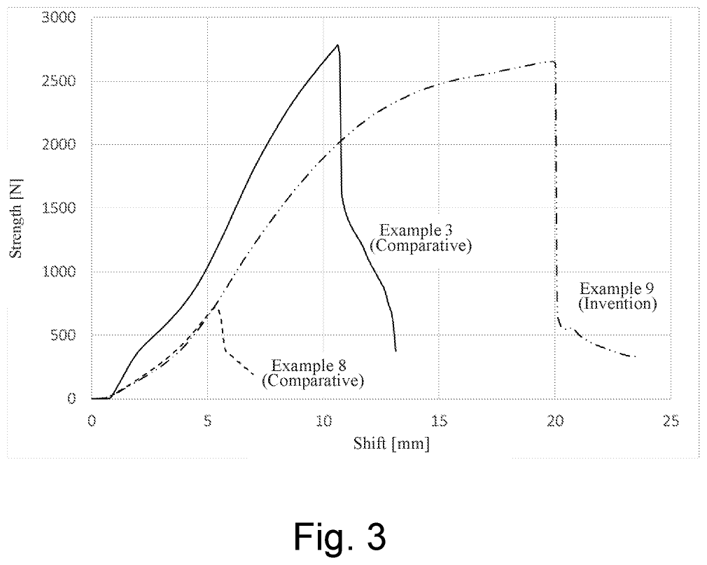

As an example, some test results are shown in FIG. 3 wherein the solid line indicates Example 3 (comparative), the dashed line indicates Example 8 (comparative) and the dash-dot line indicates Example 9 (disclosure).

Table A below shows the list of reagents used in the following examples, as well as their characteristics and suppliers.

TABLE A

| | Trade name | | |
|---|---|---|---|
| Reagents | (Acronym) | Supplier | Characteristics |
| Butadiene | (BDE) | Versalis | Purity >99.5% |
| Cyclohexane | — | Cepsa | Purity >99.5% |
| n-Butyl lithium* | (nBL) | Albemarle | Active lithium = 15% |
| Heptanoic acid | — | Sigma- | Purity >97% |
| | | Aldrich | |
| Ethanol | — | Sigma- | Purity >96% |
| | | Aldrich | |
| Di-benzoyl peroxide | Perkadox L-W75 | Akzo Nobel | At 75% in water |
| | (BPO) | | |
| 4-hydroxy-2,2,6,6-tetramethyl | (4OH-TEMPO) | Sigma- | Purity >97% |
| piperidine 1-oxyl | | Aldrich | |
| Styrene | (SM) | Versalis | Purity >99.7% |
| Ethylbenzene | (EB) | Versalis | Purity >99.0% |
| Acrylonitrile | (ACN) | Ineos | Purity >99.4% |
| Europrene ® SOL B183 | (SBR) | Versalis | Bonded polystyrene: 8- |
| | | | 12% |
| | | | Viscosity (@5% in |
| | | | styrene): 32 cPs |
| 1,1-bis(tert-butyl peroxy) | Trigonox 22-E50 | Akzo Nobel | At 50% in mineral oil |
| cyclohexane | (Tx22E50) | | |
| n-Dodecyl mercaptan | (NDM) | Arkema | Purity >97.8% |
| Octadecyl 3-(3,5-di-tert-butyl- | Irganox ® 1076 | BASF | Purity >98.0% |
| 4-hydroxyphenyl) propionate | | | |

*The n-Butyl lithium was diluted from 15% to 2% with anhydrous cyclohexane (Cepsa) before its use.

### Example 1 (Comparative)

In a 50-litre vessel, equipped with a stirrer, the following were loaded: 21.4 Kg of styrene, 3.7 Kg of ethylbenzene, 4.9 Kg of SBR Europrene® SOL B183 rubber, 11.5 g of 1,1-bis(tert-butyl peroxy)cyclohexane [Trigonox 22-E50 (Tx22E50)](radical initiator) and 55.6 g of octadecyl 3-(3,5-di-tert-butyl-4-hydroxyphenyl) propionate (Irganox® 1076) (antioxidant). The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said first plug flow reactor (PFR) (R1), was continuously added (0.15 Kg/h) with a solution of n-dodecyl mercaptan (NDM) (chain transfer agent) in ethylbenzene (EB) [60.0 g of NDM in 0.940 Kg of (EB), corresponding to a concentration of NDM in ethylbenzene equal to 6.0%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are shown in Table Ta. The characteristics of the products obtained are shown in Table 2a.

### Example 2 (Comparative)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 1208.0 g of n-butyl lithium (nBL) in solution at 2% by weight in cyclohexane were fed. Upon complete conversion, at the temperature of 115° C., the reaction mixture was fed to a second 300-litre reactor, equipped with a stirrer and a heating jacket in which a diathermic oil at a temperature of 25° C. is circulated, at which an aliquot of ethanol equal to 22.0 g was also fed so as to complete the termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 60206 g/mole and a polydispersity index (PDI) value (M_{w}/Mₙ) equal to 1.02.

The reaction mixture comprising low cis polybutadiene rubber (LCBR) and cyclohexane obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and at the same time the temperature of the autoclave was increased up to 66° C.: the solvent exchange operation was completed once 313.1 Kg of condensates were collected. The concentration of cyclohexane in the styrene solution was less than 500 ppm: the final solution was stored in a buffer tank and the concentration of low cis polybutadiene rubber (LCBR) in styrene at the end of the solvent exchange operation was equal to 26.8%.

An aliquot equal to 16.6 Kg of low cis polybutadiene rubber (LCBR) at 26.8% in styrene was transferred into a 50-litre vessel, equipped with a stirrer, to which they were subsequently fed: 9.7 Kg of styrene, 3.7 Kg of ethylbenzene, 11.5 g di 1,1-bis(tert-butyl peroxy)cyclohexane [Trigonox 22-E50 (Tx22E50)](radical initiator) and 55.6 g of octadecyl 3-(3,5-di-tert-butyl-4-hydroxyphenyl)propionate (Irganox® 1076) (antioxidant). The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with a n-dodecyl mercaptan (NDM) chain transfer agent solution in ethylbenzene (EB) [60.0 g of NDM in 0.940 Kg of (EB) corresponding to a concentration of NDM in ethylbenzene equal to 6.0%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are shown in Table Ta. The characteristics of the products obtained are shown in Table 2a.

### Example 3 (Comparative)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 967.0 g of n-butyl lithium (nBL) in solution at 2% by weight in cyclohexane were fed. Upon complete conversion, at the temperature of 113° C., the reaction mixture was fed to a second 300-litre reactor, equipped with a stirrer and a heating jacket in which a diathermic oil at a temperature of 25° C. was circulated, at which an aliquot of heptanoic acid equal to 51.0 g was also fed so as to complete the termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 77561 g/mole and a polydispersity index (PDI) value (M_{w}/Mₙ) equal to 1.04.

The reaction mixture comprising low cis butadiene rubber (LCBR) and cyclohexane obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and at the same time the temperature of the autoclave was increased up to 66° C.: the solvent exchange operation was completed once 301.2 Kg of condensates had been collected. The concentration of cyclohexane in the styrene solution was less than 500 ppm: the final solution was stored in a buffer tank and the concentration of low cis polybutadiene rubber (LCBR) in styrene at the end of the solvent exchange operation was equal to 23.4%.

An aliquot equal to 19.0 Kg of a solution of low cis polybutadiene rubber (LCBR) at 23.4% in styrene was transferred into a 50 litre-vessel, equipped with a stirrer, into which the following were subsequently fed: 7.3 Kg of styrene, 3.7 Kg of ethylbenzene, 11.5 g di 1,1-bis(tert-butyl peroxy)cyclohexane [Trigonox 22-E50 (Tx22E50)](radical initiator) and 55.6 g of octadecyl 3-(3,5-di-tert-butyl-4-hydroxyphenyl)propionate (Irganox® 1076) (antioxidant). The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with a n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second Plug Flow Reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are shown in Table 1a. The characteristics of the products obtained are shown in Table 2a.

### Example 4 (Comparative)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 806.0 g of n-butyl lithium (nBL) in solution at 2% by weight in cyclohexane were fed. Upon complete conversion, at the temperature of 111° C., the reaction mixture was fed to a second 300-litre reactor, equipped with a stirrer and a heating jacket in which a diathermic oil at a temperature of 25° C. was circulated, at which an aliquot of heptanoic acid equal to 42.0 g was also fed so as to complete the termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 91586 g/mole and a polydispersity index (PDI) value (M_{w}/Mₙ) equal to 1.06.

The reaction mixture comprising low cis polybutadiene rubber (LCBR) and cyclohexane obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and at the same time the temperature of the autoclave was increased up to 66° C.: the solvent exchange operation was completed once 289.4 Kg of condensates were collected. The concentration of cyclohexane in the styrene solution was less than 500 ppm: the final solution was stored in a buffer tank and the concentration of low cis polybutadiene rubber (LCBR) in styrene at the end of the solvent exchange operation was equal to 20.8%.

An aliquot equal to 21.4 Kg of low cis polybutadiene rubber (LCBR) at 20.8% in styrene was transferred into a 50-litre vessel, equipped with a stirrer, into which the following were subsequently fed: 4.9 Kg of styrene, 3.7 Kg of ethylbenzene, 11.5 g di 1,1-bis(tert-butyl peroxy)cyclohexane [Trigonox 22-E50 (Tx22E50)](radical initiator) and 55.6 g of octadecyl 3-(3,5-di-tert-butyl-4-hydroxyphenyl)propionate (Irganox® 1076) (antioxidant). The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with a n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are shown in Table 1a. The characteristics of the products obtained are shown in Table 2a.

### Example 5 (Comparative)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 1208.0 g of n-butyl lithium (nBL) in solution at 2% by weight in cyclohexane were fed. Upon complete conversion, at the temperature of 115° C., the reaction mixture was fed to a second 300-litre reactor, equipped with a stirrer and a heating jacket in which a diathermic oil at a temperature of 25° C. was circulated, at which an aliquot of heptanoic acid equal to 64.0 g was also fed so as to complete the termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 59731 g/mole and a polydispersity index (PDI) value (M_{w}/Mₙ) equal to 1.02.

To the reaction mixture comprising low cis polybutadiene rubber (LCBR) and cyclohexane obtained as described above, 38.1 g of di-benzoyl peroxide [Perkadox 1-W75 (BPO)] and 31.5 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining weight average molecular weight value (M_{w}) equal to 59254 g/mole and a polydispersity index (PDI) value (M_{w}/Mₙ) equal to 1.02.

The functionalised low cis polybutadiene rubber (LCBR) solution obtained as described above, was transferred to an 800-litre batch autoclave, equipped with a temperature regulator, a stirring system, a vacuum regulation system and condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 315.2 Kg of condensates were collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 27.5%.

An aliquot equal to 16.2 Kg of functionalised low cis polybutadiene rubber (LCBR) solution at 27.5% in styrene was transferred into a 50-litre vessel, equipped with a stirrer, into which the following were subsequently fed: 10.1 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 9.3 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [54.0 g of NDM in 0.946 Kg of (EB) corresponding to a concentration of NDM in ethylbenzene equal to 5.4%] and fed into a second plug flow reactor (PFR) (R2) also equipped with stirrer and temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1b. The characteristics of the products obtained are shown in Table 2b.

### Example 6 (Disclosure)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 1208.0 g of n-butyl lithium (nBL) in solution at 2% by weight in cyclohexane were fed. Upon complete conversion, at the temperature of 115° C., the reaction mixture was fed to a second 300-litre reactor, equipped with a stirrer and a heatingjacket in which a diathermic oil at a temperature of 25° C. was circulated, at which an aliquot of ethanol equal to 22.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 61001 g/mole and a polydispersity index (PDI) value (M_{w}/Mₙ) equal to 1.03.

To the reaction mixture comprising low cis polybutadiene rubber (LCBR) and cyclohexane obtained as described above, 38.1 g of di-benzoyl peroxide [Perkadox 1-W75 (BPO)] and 31.5 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining a weight average molecular weight value t (M_{w}) equal to 61256 g/mole and a polydispersity index (PDI) value (M_{w}/Mₙ) equal to 1.03.

The functionalised low cis polybutadienerubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 313.7 Kg of condensates were collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 27.0%.

An aliquot equal to 16.5 Kg of functionalised low cis polybutadiene rubber (LCBR) at 27.0% in styrene was transferred into a 50-litre vessel, equipped with a stirrer, into which the following were subsequently fed: 9.8 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 17.0 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1b. The characteristics of the products obtained are shown in Table 2b.

### Example 7 (Comparative)

To a 300-litre reactor, kept anhydrous, equipped with a stirrer and a heating jacket in which a diathermic oil at a temperature of 50° C. was circulated, were fed, in order, in nitrogen flow: 124.4 Kg of anhydrous cyclohexane, 22.0 Kg of anhydrous butadiene free from inhibitor and acetylenic hydrocarbons and, when the reaction mixture had reached the temperature of 40° C., 1208.0 g of n-butyl lithium (nBL) in solution at 2% by weight in cyclohexane were fed. Upon complete conversion, at the temperature of 115° C., the reaction mixture was fed to a second 300-litre reactor, equipped with a stirrer and a heating jacket in which a diathermic oil at a temperature of 25° C. was circulated, at which an aliquot of ethanol equal to 22.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 60986 g/mole and a polydispersity index (PDI) value (M_{w}/Mₙ) equal to 1.03.

To the reaction mixture comprising low cis polybutadiene rubber (LCBR) and cyclohexane obtained as described above, 38.1 g of di-benzoyl peroxide [Perkadox 1-W75 (BPO)] and 31.5 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining a weight average molecular weight value (M_{w}) equal to 60138 g/mole and a polydispersity index (PDI) value (M_{w}/Mₙ) equal to 1.02.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 314.6 Kg of condensates were collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 27.3%.

An aliquot equal to 16.3 Kg of functionalised low cis polybutadiene rubber (LCBR) at 27.3% in styrene was transferred into a 50-litre vessel, equipped with a stirrer, into which the following were subsequently fed: 10.0 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 22.2 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug low reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [39.0 g of NDM in 0.961 Kg of (EB) corresponding to a concentration of NDM in ethylbenzene equal to 3.9%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1b. The characteristics of the products obtained are shown in Table 2b.

### Example 8 (Comparative)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 967.0 g of n-butyl lithium (nBL) in solution at 2% by weight in cyclohexane were fed. Upon complete conversion, at a temperature of 113° C., the reaction mixture was fed to a second 300-litre reactor, equipped with a stirrer and a heating jacket in which a diathermic oil at a temperature of 25° C. was circulated, at which an aliquot of ethanol equal to 18.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 73791 g/mole and a polydispersity index (PDI) value (M_{w}/Mₙ) equal to 1.03.

To the reaction mixture comprising low cis polybutadiene rubber (LCBR) and cyclohexane obtained as described above, 30.5 g of di-benzoyl peroxide [Perkadox 1-W75 (BPO)] and 25.2 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining a weight average molecular weight value (M_{w}) equal to 73578 g/mole and a polydispersity index (PDI) value (M_{w}/Mₙ) equal to 1.04.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased up to 66° C.: the solvent exchange operation was completed once 303.9 Kg of condensates had been collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 24.1%.

An aliquot equal to 18.5 Kg of functionalised low cis polybutadiene rubber (LCBR) at 24.1% in styrene was transferred into a 50-litre vessel, equipped with a stirrer, into which the following were subsequently fed: 7.8 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 5.6 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1c. The characteristics of the products obtained are shown in Table 2c.

### Example 9 (Disclosure)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 967.0 g of n-butyl lithium (nBL) in solution at 2% by weight in cyclohexane were fed. Upon complete conversion, at a temperature of 113° C., the reaction mixture was fed to a second 300-litre reactor, equipped with a stirrer and a heating jacket in which a diathermic oil at a temperature of 25° C. was circulated, at which an aliquot of ethanol equal to 18.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 78736 g/mole and a polydispersity index (PDI) value (M_{w}/Mₙ) equal to 1.05.

To the reaction mixture comprising polybutadiene (LCBR) and cyclohexane obtained as described above, 30.5 g of di-benzoyl peroxide [Perkadox 1-W75 (BPO)] and 25.2 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised Low Cis Butadiene Rubber (LCBR) was subjected to determination of the molecular weight distribution carried out by gel permeation chromatography (GPC) operating as reported above, obtaining a weight average molecular weight value (M_{w}) equal to 78201 g/mole and a polydispersity index (PDI) value (M_{w}/Mₙ) equal to 1.04.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 298.7 Kg of condensates had been collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 22.8%.

An aliquot equal to 19.5 Kg of functionalised low cis polybutadiene rubber (LCBR) at 22.8% in styrene was transferred into a 50-litre vessel, equipped with a stirrer, into which the following were subsequently fed: 6.8 Kg of styrene, 3.7 Kg of ethylbenzene, 11.5 g of 1,1-bis(tert-butyl peroxy)cyclohexane [Trigonox 22-E50 (Tx22E50)](radical initiator) and 55.6 g of octadecyl 3-(3,5-di-tert-butyl-4-hydroxyphenyl)propionate (Irganox® 1076) (antioxidant) and 13 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [39.0 g of NDM in 0.961 Kg of (EB) corresponding to a concentration of NDM in ethylbenzene equal to 3.9%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1c. The characteristics of the products obtained are shown in Table 2c.

### Example 10 (Comparative)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 967.0 g of n-butyl lithium (nBL) in solution at 2% by weight in cyclohexane were fed. Upon complete conversion, at a temperature of 113° C., the reaction mixture was fed to a second 300-litre reactor, equipped with a stirrer and a heating jacket in which a diathermic oil at a temperature of 25° C. was circulated, at which an aliquot of heptanoic acid equal to 51.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 77568 g/mole and a polydispersity index (PDI) value (M_{w}/Mₙ) equal to 1.04.

To the reaction mixture comprising low cis polybutadiene rubber (LCBR) and cyclohexane obtained as described above, 30.5 g of di-benzoyl peroxide [Perkadox 1-W75 (BPO)] and 25.2 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene Rubber (LCBR) was subjected to determination of the molecular weight distribution carried out by gel permeation chromatography (GPC) operating as reported above, obtaining a weight average molecular weight value (M_{w}) equal to 77853 g/mole and a polydispersity index (PDI) value (M_{w}/Mₙ) equal to 1.05.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 302.0 Kg of condensates had been collected. The concentration of cyclohexane in the styrene solution was less than 500 ppm: the final solution was stored in a buffer tank and the concentration of functionalised low cis butadiene rubber (LCBR) in styrene at the end of the solvent exchange operation was equal to 23.7%.

An aliquot equal to 19.2 Kg of functionalised low cis polybutadiene rubber (LCBR) at 23.7% in styrene was transferred into a 50-litre vessel, equipped with a stirrer, into which the following were subsequently fed: 7.4 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 16.7 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [33.0 g of NDM in 0.967 Kg of (EB) corresponding to a concentration of NDM in ethylbenzene equal to 3.3%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1c. The characteristics of the products obtained are shown in Table 2c.

### Example 11 (Comparative)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 806.0 g of n-butyl lithium (nBL) in solution at 2% by weight in cyclohexane were fed. Upon complete conversion, at a temperature of 113° C., the reaction mixture was fed to a second 300-litre reactor, equipped with a stirrer and a heating jacket in which a diathermic oil at a temperature of 25° C. was circulated, at which an aliquot of ethanol equal to 15.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 89882 g/mole and a polydispersity index (PDI) value (M_{w}/Mₙ) equal to 1.05.

To the reaction mixture comprising low cis polybutadiene rubber (LCBR) and cyclohexane obtained as described above, 25.4 g of di-benzoyl peroxide [Perkadox 1-W75 (BPO)] and 21.0 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene Rubber (LCBR) was subjected to determination of the molecular weight distribution carried out by gel permeation chromatography (GPC) operating as reported above, obtaining a weight average molecular weight value (M_{w}) equal to 90026 g/mole and a polydispersity index (PDI) value (M_{w}/Mₙ) equal to 1.06.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 291.4 Kg of condensates were collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 21.2%.

An aliquot equal to 21.0 Kg of functionalised low cis polybutadiene rubber (LCBR) at 21.2% in styrene was transferred into a 50-litre vessel, equipped with a stirrer, into which the following were subsequently fed: 5.3 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 5.6 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1d. The characteristics of the products obtained are shown in Table 2d.

### Example 12 (Disclosure)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 806.0 g of n-butyl lithium (nBL) in solution at 2% by weight in cyclohexane were fed. Upon complete conversion, at a temperature of 110° C., the reaction mixture was fed to a second 300-litre reactor, equipped with a stirrer and a heating jacket in which a diathermic oil at a temperature of 25° C. was circulated, at which an aliquot of heptanoic acid equal to 42.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 90566 g/mole and a polydispersity index (PDI) value (M_{w}/Mₙ) equal to 1.06.

To the reaction mixture comprising low cis polybutadiene rubber (LCBR) and cyclohexane obtained as described above, 25.4 g of di-benzoyl peroxide [Perkadox 1-W75 (BPO)] and 21.0 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining a weight average molecular weight value (M_{w}) equal to 89823 g/mole and a polydispersity index (PDI) value (M_{w}/Mₙ) equal to 1.05.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 292.9 Kg of condensates were collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 21.5%.

An aliquot equal to 20.7 Kg of functionalised low cis polybutadiene rubber (LCBR) at 21.5% in styrene was transferred into a 50-litre vessel, equipped with a stirrer, into which the following were subsequently fed: 5.6 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 9.3 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [45.0 g of NDM in 0.955 Kg of (EB) corresponding to a concentration of NDM in ethylbenzene equal to 4.5%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1c. The characteristics of the products obtained are shown in Table 2d.

### Example 13 (Comparative)

The following were fed, in order, in nitrogen flow, into a 300-litre reactor, kept anhydrous, equipped with a stirrer and a heating jacket in which a diathermic oil at a temperature of 50° C. was circulated: 124.4 Kg of anhydrous cyclohexane, 22.0 Kg of anhydrous butadiene free from inhibitor and acetylenic hydrocarbons and, when the reaction mixture had reached the temperature of 40° C., 806.0 g of n-butyl lithium (nBL) in solution at 2% by weight in cyclohexane were fed. Upon complete conversion, at a temperature of 110° C., the reaction mixture was fed to a second 300-litre reactor, equipped with a stirrer and a heating jacket in which a diathermic oil at a temperature of 25° C. was circulated, at which an aliquot of heptanoic acid equal to 42.0 g was also fed so as to complete termination of the chain ends.

A sample of low cis polybutadiene rubber (LCBR) was subjected to determination of the molecular weight distribution carried out by gel permeation chromatography (GPC) operating as reported above, obtaining a weight average molecular weight value (M_{w}) equal to 91156 g/mole and a polydispersity index (PDI) value (M_{w}/Mₙ) equal to 1.06.

To the reaction mixture comprising low cis polybutadiene rubber (LCBR) and cyclohexane obtained as described above, 25.4 g of di-benzoyl peroxide [Perkadox 1-W75 (BPO)] and 21.0 g of 4-hydroxy-2,2,6,6-tetramethyl piperidine 1-oxyl (40H-TEMPO) were added: the mixture thus obtained was thermostated at a temperature of 105° C. and kept at said temperature, under stirring, for 3 hours up to complete functionalization of the low cis polybutadiene rubber (LCBR) chains with 4-hydroxy-2,2,6,6-tetramethyl piperidine 1-oxyl (40H-TEMPO).

A sample of functionalised low cis polybutadiene rubber (LCBR) was subjected to determination of the molecular weight distribution carried out by gel permeation chromatography (GPC) operating as reported above, obtaining a weight average molecular weight value (M_{w}) equal to 90992 g/mole and a polydispersity index (PDI) value (M_{w}/Mₙ) equal to 1.06.

The functionalised low cis polybutadiene rubber (LCBR) solution obtained as described above, was transferred to an 800-litre batch autoclave, equipped with a temperature regulator, a stirring system, a vacuum regulation system and a condensate collection system: the autoclave was thermostated at 25° C. and placed under vacuum, at a pressure of 70 mbar. As soon as the presence of liquid was observed in the condensate collection system, 248.8 Kg of styrene were slowly added and, at the same time, the temperature of the autoclave was increased to up to 66° C.: the solvent exchange operation was completed once 290.9 Kg of condensates had been collected. The concentration of cyclohexane in the styrene solution was less than 500 ppm: the final solution was stored in a buffer tank and the concentration of functionalised low cis polybutadiene rubber (LCBR) in styrene at the end of the solvent exchange operation was equal to 21.1%.

An aliquot equal to 21.1 Kg of functionalised low cis polybutadiene rubber (LCBR) at 21.1% in styrene was transferred into a 50-litre vessel, equipped with a stirrer, into which the following were subsequently fed: 5.2 Kg of styrene, 3.7 Kg of ethylbenzene, 11.5 g di 1,1-bis(tert-butyl peroxy)cyclohexane [Trigonox 22-E50 (Tx22E50)](radical initiator), 55.6 g of octadecyl 3-(3,5-di-tert-butyl-4-hydroxyphenyl) propionate (Irganox® 1076) (antioxidant) and 16.7 g of n-dodecyl mercaptan (NDM) chain transfer agent. The solution thus obtained was fed continuously, with a flow rate of 3.8 Kg/h, into a first 10-litre plug flow reactor (PFR) (R1) equipped with a stirrer and a temperature regulation system. Immediately before entering the first plug flow reactor (PFR) (R1), a stream of acrylonitrile was added to the solution with a flow rate of 0.7 Kg/h. The thermal profile of the reactor was increasing from 113° C. to 122° C. and the stirring speed was kept constant at 80 rpm. In said first plug flow reactor (PFR) (R1), the prepolymerisation with grafting and phase inversion was carried out. The mixture leaving said plug flow reactor (PFR) (R1) was added continuously (0.15 Kg/h) with an n-dodecyl mercaptan (NDM) chain transfer agent solution in ethylbenzene (EB) [33.0 g of NDM in 0.967 Kg of (EB) corresponding to a concentration of NDM in ethylbenzene equal to 3.3%] and fed into a second plug flow reactor (PFR) (R2) also equipped with a stirrer and a temperature regulation system, with reactor thermal profile increasing from 139° C. to 150° C. and stirring speed kept constant at 10 rpm.

The mixture obtained was fed into a devolatilizer operating under vacuum at a temperature of 255° C. in order to remove the unreacted styrene and the solvent from the copolymer and thus obtain the final copolymer. The reaction conditions used in the process are reported in Table 1c. The characteristics of the products obtained are shown in Table 2d.

TABLE 1a

| | | EXAMPLE 1 | EXAMPLE 2 | EXAMPLE 3 | EXAMPLE 4 |
|---|---|---|---|---|---|
| | | (comparative) | (comparative) | (comparative) | (comparative) |
| Butadiene | Kg | — | 22.0 | 22.0 | 22.0 |
| Cyclohexane | Kg | — | 124.4 | 124.4 | 124.4 |
| nBL @2% | g | — | 1208.0 | 967.0 | 806.0 |
| Heptanoic Acid | g | — | — | 51.0 | 42.0 |
| Heptanoic Acid | ppm | — | — | 348 | 287 |
| Ethanol | g | — | 22.0 | — | _— |
| Ethanol | ppm | — | 150 | — | _— |
| BPO | g | — | 0 | 0 | 0 |
| BPO | ppm | — | 0 | 0 | 0 |
| 4OH-TEMPO | g | — | 0 | 0 | 0 |
| 4OH-TEMPO | ppm | — | 0 | 0 | 0 |
| Styrene to solvent change | Kg | — | 248.8 | 248.8 | 248.8 |
| Condensates collected at the end of the solvent | Kg | — | 313.1 | 301.2 | 289.4 |
| exchange | | | | | |
| LCBR concentration in styrene | % | — | 26.8 | 23.4 | 20.8 |
| LCBR in styrene fed | Kg | — | 16.6 | 19.0 | 21.4 |
| SBR | Kg | 4.9 | — | — | — |
| Styrene | Kg | 21.4 | 9.7 | 7.3 | 4.9 |
| Ethylbenzene | Kg | 3.7 | 3.7 | 3.7 | 3.7 |
| Tx22E50 | g | 11.5 | 11.5 | 11.5 | 11.5 |
| Tx22E50 | ppm | 310 | 310 | 310 | 310 |
| NDM in R1 | g | 0 | 0 | 0 | 0 |
| NDM in R1 | ppm | 0 | 0 | 0 | 0 |
| Irganox ® 1076 | g | 55.6 | 55.6 | 55.6 | 55.6 |
| Irganox ® 1076 | ppm | 1500 | 1500 | 1500 | 1500 |
| Acrylonitrile | Kg/h | 0.7 | 0.7 | 0.7 | 0.7 |
| Reaction mixture flow rate in R1 | Kg/h | 4.5 | 4.5 | 4.5 | 4.5 |
| T1 in R1 | ° C. | 113 | 113 | 113 | 113 |
| T2 in R1 | ° C. | 122 | 122 | 122 | 122 |
| R1 stirrer revolutions | rpm | 80 | 80 | 80 | 80 |
| Concentration of NDM solution in ethylbenzene at | % | 6.0 | 6.0 | 4.5 | 4.5 |
| R2 | | | | | |
| Solution flow rate of NDM in ethylbenzene at R2 | Kg/h | 0.15 | 0.15 | 0.15 | 0.15 |
| NDM concentration in R2 | ppm | 2000 | 2000 | 1500 | 1500 |
| T3 in R2 | ° C. | 139 | 139 | 139 | 139 |
| T4 in R2 | ° C. | 150 | 150 | 150 | 150 |
| R2 stirrer revolutions | rpm | 10 | 10 | 10 | 10 |
| Devolatilisation temperature | ° C. | 255 | 255 | 255 | 255 |

TABLE 1b

| | | EXAMPLE 5 | EXAMPLE 6 | EXAMPLE 7 |
|---|---|---|---|---|
| | | (comparative) | (disclosure) | (comparative) |
| Butadiene | Kg | 22.0 | 22.0 | 22.0 |
| Cyclohexane | Kg | 124.4 | 124.4 | 124.4 |
| nBL @2% | g | 1208.0 | 1208.0 | 1208.0 |
| Heptanoic Acid | g | 64.0 | — | — |
| Heptanoic Acid | ppm | 437 | — | — |
| Ethanol | g | — | 22.0 | 22.0 |
| Ethanol | ppm | — | 150 | 150 |
| BPO | g | 38.1 | 38.1 | 38.1 |
| BPO | ppm | 260 | 260 | 260 |
| 4OH-TEMPO | g | 31.5 | 31.5 | 31.5 |
| 4OH-TEMPO | ppm | 215 | 215 | 215 |
| Styrene to solvent exchange | Kg | 248.8 | 248.8 | 248.8 |
| Condensates collected at the end of the solvent exchange | Kg | 315.2 | 313.7 | 314.6 |
| Functionalised LCBR concentration in styrene | % | 27.5 | 27.0 | 27.3 |
| Functionalised LCBR in styrene fed | Kg | 16.2 | 16.5 | 16.3 |
| Styrene | Kg | 10.1 | 9.8 | 10.0 |
| Ethylbenzene | Kg | 3.7 | 3.7 | 3.7 |
| Tx22E50 | g | 11.5 | 11.5 | 11.5 |
| Tx22E50 | ppm | 310 | 310 | 310 |
| NDM in R1 | g | 9.3 | 17.0 | 22.2 |
| NDM in R1 | ppm | 250 | 450 | 600 |
| Irganox ® 1076 | g | 55.6 | 55.6 | 55.6 |
| Irganox ® 1076 | ppm | 1500 | 1500 | 1500 |
| Acrylonitrile | Kg/h | 0.7 | 0.7 | 0.7 |
| Reaction mixture flow rate in R1 | Kg/h | 4.5 | 4.5 | 4.5 |
| T1 in R1 | ° C. | 113 | 113 | 113 |
| T2 in R1 | ° C. | 122 | 122 | 122 |
| R1 stirrer revolutions | rpm | 80 | 80 | 80 |
| Concentration of NDM solution in ethylbenzene at R2 | % | 5.4 | 4.5 | 4.5 |
| Solution flow rate of NDM in ethylbenzene at R2 | Kg/h | 0.15 | 0.15 | 0.15 |
| NDM concentration in R2 | ppm | 1800 | 1500 | 1300 |
| T3 in R2 | ° C. | 139 | 139 | 139 |
| T4 in R2 | ° C. | 150 | 150 | 150 |
| R2 stirrer revolutions | rpm | 10 | 10 | 10 |
| Devolatilisation temperature | ° C. | 255 | 255 | 255 |

TABLE 1c

| | | EXAMPLE 8 | EXAMPLE 9 | EXAMPLE 10 |
|---|---|---|---|---|
| | | (comparative) | (disclosure) | (comparative) |
| Butadiene | Kg | 22.0 | 22.0 | 22.0 |
| Cyclohexane | Kg | 124.4 | 124.4 | 124.4 |
| nBL @2% | g | 967.0 | 967.0 | 967.0 |
| Heptanoic acid | g | — | — | 51.0 |
| Heptanoic acid | ppm | — | — | 348 |
| Ethanol | g | 18.0 | 18.0 | — |
| Ethanol | ppm | 123 | 123 | — |
| BPO | g | 30.5 | 30.5 | 30.5 |
| BPO | ppm | 208 | 208 | 208 |
| 4OH-TEMPO | g | 25.2 | 25.2 | 25.2 |
| 4OH-TEMPO | ppm | 172 | 172 | 172 |
| Styrene to solvent exchange | Kg | 248.8 | 248.8 | 248.8 |
| Condensates collected at the end of the solvent exchange | Kg | 303.9 | 298.7 | 302.0 |
| Functionalised LCBR concentration in styrene | % | 24.1 | 22.8 | 23.7 |
| Functionalised LCBR in styrene fed | Kg | 18.5 | 19.5 | 19.2 |
| Styrene | Kg | 7.8 | 6.8 | 7.4 |
| Ethylbenzene | Kg | 3.7 | 3.7 | 3.7 |
| Tx22E50 | g | 11.5 | 11.5 | 11.5 |
| Tx22E50 | ppm | 310 | 310 | 310 |
| NDM in R1 | g | 5.6 | 13.0 | 16.7 |
| NDM in R1 | ppm | 150 | 350 | 450 |
| Irganox ® 1076 | g | 55.6 | 55.6 | 55.6 |
| Irganox ® 1076 | ppm | 1500 | 1500 | 1500 |
| Acrylonitrile | Kg/h | 0.7 | 0.7 | 0.7 |
| Reaction mixture flow rate in R1 | Kg/h | 4.5 | 4.5 | 4.5 |
| T1 in R1 | ° C. | 113 | 113 | 113 |
| T2 in R1 | ° C. | 122 | 122 | 122 |
| R1 stirrer revolutions | rpm | 80 | 80 | 80 |
| Concentration of NDM solution in ethylbenzene at R2 | % | 4.5 | 3.9 | 3.3 |
| Solution flow rate of NDM in ethylbenzene at R2 | Kg/h | 0.15 | 0.15 | 0.15 |
| NDM concentration in R2 | ppm | 1500 | 1300 | 1100 |
| T3 in R2 | ° C. | 139 | 139 | 139 |
| T4 in R2 | ° C. | 150 | 150 | 150 |
| R2 stirrer revolutions | rpm | 10 | 10 | 10 |
| Devolatilisation temperature | ° C. | 255 | 255 | 255 |

TABLE 1d

| | | EXAMPLE 11 | EXAMPLE 12 | EXAMPLE 13 |
|---|---|---|---|---|
| | | (comparative) | (disclosure) | (comparative) |
| Butadiene | Kg | 22.0 | 22.0 | 22.0 |
| Cyclohexane | Kg | 124.4 | 124.4 | 124.4 |
| nBL @2% | g | 806.0 | 806.0 | 806.0 |
| Heptanoic acid | g | — | 42.0 | 42.0 |
| Heptanoic acid | ppm | — | 287 | 287 |
| Ethanol | g | 15.0 | — | — |
| Ethanol | ppm | 102 | — | — |
| BPO | g | 25.4 | 25.4 | 25.4 |
| BPO | ppm | 173 | 173 | 173 |
| 4OH-TEMPO | g | 21.0 | 21.0 | 21.0 |
| 4OH-TEMPO | ppm | 143 | 143 | 143 |
| Styrene to solvent exchange | Kg | 248.8 | 248.8 | 248.8 |
| Condensates collected at the end of the solvent exchange | Kg | 291.4 | 292.9 | 290.9 |
| Functionalised LCBR concentration in styrene | % | 21.2 | 21.5 | 21.1 |
| Functionalised LCBR in styrene fed | Kg | 21.0 | 20.7 | 21.1 |
| Styrene | Kg | 5.3 | 5.6 | 5.2 |
| Ethylbenzene | Kg | 3.7 | 3.7 | 3.7 |
| Tx22E50 | g | 11.5 | 11.5 | 11.5 |
| Tx22E50 | ppm | 310 | 310 | 310 |
| NDM in R1 | g | 5.6 | 9.3 | 16.7 |
| NDM in R1 | ppm | 150 | 250 | 450 |
| Irganox ® 1076 | g | 55.6 | 55.6 | 55.6 |
| Irganox ® 1076 | ppm | 1500 | 1500 | 1500 |
| Acrylonitrile | Kg/h | 0.7 | 0.7 | 0.7 |
| Reaction mixture flow rate in R1 | Kg/h | 4.5 | 4.5 | 4.5 |
| T1 in R1 | ° C. | 113 | 113 | 113 |
| T2 in R1 | ° C. | 122 | 122 | 122 |
| R1 stirrer revolutions | rpm | 80 | 80 | 80 |
| Concentration of NDM solution in ethylbenzene at R2 | % | 4.5 | 4.5 | 3.3 |
| Solution flow rate of NDM in ethylbenzene at R2 | Kg/h | 0.15 | 0.15 | 0.15 |
| NDM concentration in R2 | ppm | 1500 | 1500 | 1100 |
| T3 in R2 | ° C. | 139 | 139 | 139 |
| T4 in R2 | ° C. | 150 | 150 | 150 |
| R2 stirrer revolutions | rpm | 10 | 10 | 10 |
| Devolatilisation temperature | ° C. | 255 | 255 | 255 |

TABLE 2a

| | | EXAMPLE 1 | | | |
|---|---|---|---|---|---|
| | | (comparative) | EXAMPLE 2 | EXAMPLE 3 | EXAMPLE 4 |
| | | SBR Europrene | (comparative) | (comparative) | (comparative) |
| M_{w} nominal LCBR | | SOL B183 | 60000 | 75000 | 90000 |
| NSG | — | 0 | 0 | 0 | 0 |
| NDM in R1 | ppm | 0 | 0 | 0 | 0 |
| M_{w} SBR | g/mole | 115477 | — | — | — |
| M_{w} LCBR | | — | 60206 | 77561 | 91586 |
| M_{w}/Mₙ LCBR | — | 1.25 | 1.02 | 1.04 | 1.06 |
| 1,4-cis LCBR | % | 40.5 | 41.2 | 42.3 | 42.6 |
| 1,4-trans LCBR | % | 50.6 | 51.7 | 50.3 | 49.7 |
| 1,2-vinyl LCBR | % | 8.9 | 7.1 | 7.4 | 7.7 |
| % PS in SBR | | 11.3 | — | — | — |
| LCBR in ABS | % | 15.3 | 15.7 | 14.6 | 15.2 |
| Acrylonitrile in ABS | % | 19.5 | 19.3 | 20.5 | 19.7 |
| Swelling Index | — | 13.2 | 16.0 | 16.3 | 13.0 |
| M_{w} polymeric matrix (SAN) in ABS | g/mole | 126588 | 123584 | 133183 | 115243 |
| M_{w}/Mₙ polymeric matrix (SAN) in ABS | — | 2.74 | 2.83 | 3.03 | 3.24 |
| M_{w} free SBR in ABS | g/mole | 37000 | — | — | — |
| M_{w} free LCBR in ABS | | — | 21520 | 26537 | 29821 |
| M_{w}/Mₙ free LCBR in ABS | — | 2.02 | 1.96 | 1.96 | 2.02 |
| 1,4-cis free LCBR in ABS | % | 40.8 | 41.6 | 42.6 | 42.8 |
| 1,4-trans free LCBR in ABS | % | 50.7 | 51.1 | 49.9 | 49.8 |
| 1,2-vinyl free LCBR in ABS | % | 8.5 | 7.3 | 7.5 | 7.4 |
| Average volumetric diameter of rubber particles | μm | 0.448 | 0.368 | 0.450 | 0.451 |
| “Dispersity Factor 1” of rubber particle diameters | — | 1.14 | 1.18 | 1.23 | 1.27 |
| % of rubber particles with a volumetric diameter > 0.40 μm | % | 64.9 | 26.2 | 45.1 | 55.8 |
| Particles containing occlusions/ | % | 2.5 | 1.0 | 1.1 | 1.2 |
| Particles without occlusions | | | | | |
| $\frac{( {M}_{w} ) LCBR * Chain transfer agent in R 1}{{( Average volumetric diameter of rubber particles )}^{3}}$ | $\frac{( g / mole ) * ( ppm )}{( {μm}^{3} )}$ | 0 | 0 | 0 | 0 |
| MFI@220° C./10 Kg | g/10′ | 14.2 | 12.4 | 14.2 | 14.7 |
| Impact resistance IZOD@23° C. (ISO 180/1A) | kJ/m² | 16.1 | 16.1 | 23.7 | 17.5 |
| Gloss@20° | — | 59 | 63 | 58 | 60 |
| Gloss Sensitivity | — | 1.17 | 1.09 | 1.33 | 1.10 |
| Elastic modulus | MPa | 2230 | 2390 | 2410 | 2120 |
| Elongation at yield | % | 20.2 | 14.5 | 18.8 | 37.1 |
| Stress at break | MPa | 33.1 | 33.8 | 33.4 | 29.8 |
| Stress at yield | MPa | 45.5 | 49.3 | 46.2 | 40.7 |
| Energy at break | J | 17.3 | 16.1 | 18.1 | 17.6 |
| Diplacement at break | mm | 10.1 | 9.8 | 10.7 | 10.9 |
| Puncture resistance | J * mm | 174.7 | 157.8 | 193.7 | 191.8 |
| $\frac{Mw {LCBR}_{1} * \frac{4}{3} * π * {( {D}_{vm} )}^{3} * \% {Particles}_{> 0.4 μ m} * NSG}{{M}_{w} SAN * {Ratio}_{occluded Part . / non - occluded Part .}}$ | μm³ | 0 | 0 | 0 | 0 |

TABLE 2b

| | | EXAMPLE 5 | EXAMPLE 6 | EXAMPLE 7 |
|---|---|---|---|---|
| | | (comparative) | (disclosure) | (comparative) |
| M_{w} nominal LCBR | g/mole | 60000 | 60000 | 60000 |
| NSG | — | 0.5 | 0.5 | 0.5 |
| NDM in R1 | ppm | 250 | 450 | 600 |
| M_{w} LCBR | g/mole | 59731 | 61001 | 60986 |
| M_{w}/Mₙ LCBR | — | 1.02 | 1.03 | 1.03 |
| 1,4-cis LCBR | % | 42.1 | 42.3 | 41.9 |
| 1,4-trans LCBR | % | 50.5 | 50.3 | 50.9 |
| 1,2-vinyl LCBR | % | 7.4 | 7.4 | 7.2 |
| M_{w} functionalised LCBR | g/mole | 59254 | 61256 | 60138 |
| M_{w}/Mₙ functionalised LCBR | — | 1.02 | 1.03 | 1.02 |
| 1,4-cis in functionalised LCBR | % | 43.5 | 41.8 | 42.1 |
| 1,4-trans in functionalised LCBR | % | 49.2 | 50.8 | 50.8 |
| 1,2-vinyl in functionalised LCBR | % | 7.3 | 7.4 | 7.1 |
| Functionalised LCBR in ABS | % | 15.5 | 15.4 | 15.6 |
| Acrylonitrile in ABS | % | 19.7 | 19.3 | 19.4 |
| Swelling Index | — | 17. | 12.2 | 10.7 |
| M_{w} polymeric matrix (SAN) in ABS | g/mole | 124981 | 109987 | 102986 |
| M_{w}/Mₙ polymeric matrix (SAN) in ABS | — | 2.88 | 2.33 | 2.52 |
| M_{w} free functionalised LCBR in ABS | g/mole | 21385 | 22687 | 21986 |
| M_{w}/Mₙ free functionalised LCBR in ABS | — | 1.99 | 2.01 | 2.00 |
| 1,4-cis free functionalised LCBR in ABS | % | 42.5 | 42.5 | 42.1 |
| 1,4-trans free functionalised LCBR in ABS | % | 50.1 | 49.9 | 50.6 |
| 1,2-vinyl free functionalised LCBR in ABS | % | 7.4 | 7.6 | 7.3 |
| Volumetric diameter of rubber particles | μm | 0.165 | 0.333 | 0.482 |
| “Dispersity Factor 1” of rubber particle diameters | — | 1.13 | 1.27 | 1.29 |
| % of rubber particles with a volumetric diameter > 0.40 μm | % | 0 | 33.9 | 48.6 |
| Particles containing occlusions/ | — | 0.1 | 1.5 | 2.0 |
| Particles without occlusions | | | | |
| $\frac{( {M}_{w} ) LCBR * Chain transfer agent in R 1}{{( Average volumetric diameter of rubber particles )}^{3}}$ | $\frac{( g / mole ) * ( ppm )}{( {μm}^{3} )}$ | 3.3 | 0.7 | 0.3 |
| MFI@220° C./10 Kg | g/10′ | 11.6 | 15.7 | 14.7 |
| Impact resistance IZOD@23°° C. (ISO 180/1A) | kJ/m² | 3.4 | 18.0 | 17.7 |
| Gloss@20° | — | 78 | 71 | 59 |
| Gloss Sensitivity | — | 0.36 | 0.35 | 1.14 |
| Elastic modulus | MPa | 2310 | 2180 | 2030 |
| Elongation at yield | % | 6.9 | 21.3 | 22.5 |
| Stress at break | MPa | 44.4 | 29.8 | 30.5 |
| Stress at yield | MPa | 50.1 | 41.5 | 43.4 |
| Energy at break | J | 1.3 | 29.2 | 15.8 |
| Displacement at break | mm | 4.2 | 19.1 | 11.1 |
| Puncture resistance | J * mm | 5.5 | 557.7 | 175.4 |
| $\frac{Mw {LCBR}_{1} * \frac{4}{3} * π * {( {D}_{vm} )}^{3} * \% {Particelle}_{> 0.4 μ m} * NSG}{{M}_{w} SAN * {Ratio}_{occluded Part . / non - occluded Part .}}$ | μm³ | 0 | 0.36 | 1.22 |

TABLE 2c

| | | EXAMPLE 8 | EXAMPLE 9 | EXAMPLE 10 |
|---|---|---|---|---|
| | | (comparative) | (disclosure) | (comparative) |
| M_{w} nominal LCBR | g/mole | 75000 | 75000 | 75000 |
| NSG | — | 0.5 | 0.5 | 0.5 |
| NDM in R1 | ppm | 150 | 350 | 450 |
| M_{w} LCBR | g/mole | 73791 | 78736 | 77568 |
| M_{w}/Mₙ LCBR | — | 1.03 | 1.05 | 1.04 |
| 1,4-cis LCBR | % | 42.9 | 42.5 | 42.3 |
| 1,4-trans LCBR | % | 49.5 | 50.2 | 50.1 |
| 1,2-vinyl LCBR | % | 7.6 | 7.3 | 7.6 |
| M_{w} functionalised LCBR | g/mole | 73578 | 78201 | 77853 |
| M_{w}/Mₙ functionalised LCBR | — | 1.04 | 1.04 | 1.05 |
| 1,4-cis functionalised LCBR | % | 42.2 | 43.1 | 42.5 |
| 1,4-trans functionalised LCBR | % | 50.3 | 49.3 | 50.3 |
| 1,2-vinyl functionalised LCBR | % | 7.5 | 7.6 | 7.2 |
| Functionalised LCBR in ABS | % | 15.4 | 15.7 | 15.6 |
| Acrylonitrile in ABS | % | 19.3 | 19.2 | 19.4 |
| Swelling Index | — | 15.3 | 12.1 | 14.2 |
| M_{w} polymeric matrix (SAN) in ABS | g/mole | 140770 | 118392 | 117123 |
| M_{w}/Mₙ polymeric matrix (SAN) in ABS | — | 2.88 | 2.43 | 2.33 |
| M_{w} free functionalised LCBR in ABS | g/mole | 25842 | 25981 | 26087 |
| M_{w}/Mₙ free functionalised LCBR in ABS | — | 1.93 | 2.0 | 1.98 |
| 1,4-cis free functionalised LCBR in ABS | % | 42.8 | 42.6 | 42.0 |
| 1,4-trans free functionalised LCBR in ABS | % | 49.4 | 49.9 | 50.3 |
| 1,2-vinyl free functionalised LCBR in ABS | % | 7.8 | 7.5 | 7.7 |
| Average volumetric diameter of rubber particles | μm | 0.178 | 0.332 | 0.470 |
| “Dispersity Factor 1” of rubber particle diameters | — | 1.11 | 1.26 | 1.29 |
| % of particles with a volumetric diameter > 0.40 μm | % | 2.6 | 36.1 | 53.2 |
| Particles containing occlusions/ | — | 0.1 | 1.4 | 2.0 |
| Particles without occlusions | | | | |
| $\frac{( {M}_{w} ) LCBR * Chain transfer agent in R 1}{{( Average volumetric diameter of rubber particles )}^{3}}$ | $\frac{( g / mole ) * ( ppm )}{( {μm}^{3} )}$ | 2.0 | 0.8 | 0.3 |
| MFI@220°C./10 Kg | g/10′ | 9.1 | 14.2 | 13.6 |
| Impact resistance IZOD@23° C. (ISO 180/1A) | kJ/m2 | 3.5 | 18.9 | 19.2 |
| Gloss@20° | — | 72 | 70 | 58 |
| Gloss Sensitivity | — | 0.35 | 0.31 | 1.20 |
| Elastic modulus | MPa | 2360 | 2170 | 2120 |
| Elongation at yield | % | 5.7 | 18.7 | 21.1 |
| Stress at break | MPa | 39.0 | 33.0 | 32.5 |
| Yield Stress | MPa | 48.9 | 44.7 | 45.0 |
| Energy at break | J | 1.2 | 30.9 | 16.9 |
| Displacement at break | mm | 4.1 | 19.8 | 10.2 |
| Puncture resistance | J * mm | 4.9 | 611.8 | 172.4 |
| $\frac{Mw {LCBR}_{1} * \frac{4}{3} * π * {( {D}_{vm} )}^{3} * \% {Particelle}_{> 0.4 μ m} * NSG}{{M}_{w} SAN * {Ratio}_{occluded Part . / non - occluded Part .}}$ | μm³ | 0.06 | 0.43 | 1.29 |

TABLE 2d

| | | EXAMPLE 11 | EXAMPLE 12 | EXAMPLE 13 |
|---|---|---|---|---|
| | | (comparative) | (disclosure) | (comparative) |
| M_{w} nominal LCBR | g/mole | 90000 | 90000 | 90000 |
| NSG | — | 0.5 | 0.5 | 0.5 |
| NDM in R1 | ppm | 150 | 250 | 450 |
| M_{w} LCBR | g/mole | 89882 | 90566 | 91156 |
| M_{w}/Mₙ LCBR | — | 1.05 | 1.06 | 1.06 |
| 1,4-cis LCBR | % | 42.8 | 43.1 | 42.1 |
| 1,4-trans LCBR | % | 49.4 | 49.4 | 50.6 |
| 1,2-vinyl LCBR | % | 7.8 | 7.5 | 7.3 |
| M_{w} functionalised LCBR | g/mole | 90026 | 89823 | 90992 |
| M_{w}/Mₙ functionalised LCBR | — | 1.06 | 1.05 | 1.06 |
| 1,4-cis functionalised LCBR | % | 42.5 | 42.9 | 42.5 |
| 1,4-trans functionalised LCBR | % | 49.8 | 49.4 | 50.3 |
| 1,2-vinyl functionalised LCBR | % | 7.7 | 7.7 | 7.2 |
| Functionalised LCBR in ABS | % | 15.4 | 15.6 | 15.4 |
| Acrylonitrile in ABS | % | 19.1 | 19.4 | 19.3 |
| Swelling Index | — | 13.7 | 10.9 | 10.6 |
| M_{w} polymeric matrix (SAN) in ABS | g/mole | 126340 | 124393 | 109794 |
| M_{w}/Mₙ polymeric matrix (SAN) in ABS | — | 3.14 | 2.86 | 2.54 |
| M_{w} free functionalised LCBR in ABS | g/mole | 30856 | 30256 | 30225 |
| M_{w}/Mₙ free functionalised LCBR in ABS | — | 2.03 | 1.99 | 2.03 |
| 1,4-cis free functionalised LCBR in ABS | % | 42.5 | 42.8 | 42.6 |
| 1,4-trans free functionalised LCBR in ABS | % | 49.8 | 49.5 | 49.8 |
| 1,2-vinyl free functionalised LCBR in ABS | % | 7.7 | 7.7 | 7.6 |
| Average volumetric diameter of rubber particles | μm | 0.195 | 0.298 | 0.485 |
| “Dispersity Factor 1” of rubber particle diameters | — | 1.11 | 1.21 | 1.33 |
| % of rubber particles with volumetric diameter > 0.40 μm | % | 1.3 | 30.9 | 63.7 |
| Particles containing occlusions/ | — | 0.1 | 1.5 | 2.1 |
| Particles without occlusions | | | | |
| $\frac{( {M}_{w} ) LCBR * Chain transfer agent in R 1}{{( Average volumetric diameter of rubber particles )}^{3}}$ | $\frac{( g / mole ) * ( ppm )}{( {μm}^{3} )}$ | 1.8 | 0.9 | 0.4 |
| MFI@220° C./10 Kg | g/10′ | 12.4 | 13.9 | 15.5 |
| Impact resistance IZOD@23° C. (ISO 180/1A) | KJ/m² | 6.2 | 17.2 | 18.1 |
| Gloss@20° | — | 67 | 65 | 58 |
| Gloss Sensitivity | — | 0.36 | 0.38 | 1.17 |
| Elastic modulus | MPa | 2340 | 2120 | 1970 |
| Elongation at yield | % | 11.3 | 14.4 | 46.7 |
| Stress at break | MPa | 34.1 | 32.5 | 31.2 |
| Stress at yield | MPa | 46.7 | 44.2 | 38.9 |
| Energy at break | J | 1.2 | 28.9 | 17.2 |
| Displacement at break | mm | 4.1 | 19.6 | 11.5 |
| Puncture resistance | J * mm | 4.9 | 566.4 | 197.8 |
| $\frac{Mw {LCBR}_{1} * \frac{4}{3} * π * {( {D}_{vm} )}^{3} * \% {Particles}_{> 0.4 μ m} * NSG}{{M}_{w} SAN * {Ratio}_{occluded Part . / non - occluded Part .}}$ | μm³ | 0.05 | 0.028 | 1.99 |

The results shown in Tables 2a-2d show the following.

Comparative Examples 1-4, in which a non-functionalised styrene-butadiene rubber (SBR) having a weight average molecular weight (M_{w}) equal to 115447 (Comparative Example 1) and a non-functionalised monodisperse low cis polybutadiene rubber (LCBR) with different weight average molecular weight (M_{w}), i.e., 60206 g/mole in Example 2 (comparative), 77561 g/mole in Example 3 (comparative) and 91586 g/mole in Example 4 (comparative), copolymers are obtained which are able to exhibit only some of the properties of copolymer of the present disclosure: in particular, using non-functionalised rubbers, it is possible to obtain products characterised by good gloss values (i.e. values from 58 to 63) and impact resistance (i.e., values greater than 16 kJ/m²) but high gloss sensitivity values (i.e. values greater than 1) and low puncture resistance values [i.e. values less than 400 J*mm]. For these copolymers, in fact:
the volumetric diameter of the particles is too high [greater than 0.37 μm, with the exception of Example 2 (comparative)];
the percentage of particles with an average volumetric diameter greater than 0.40 μm is too high [greater than 50%, with the exception of Example 2 (comparative) and Example 3 (comparative)];
the ratio between Particles with Occlusions/Particles without Occlusions is greater than 1.9, with the exception of Example 2 (comparative), Example 3 (comparative) and Example 4 (comparative).

It should be noted that the use of functionalised low cis polybutadiene rubber (LCBR) with a functional group allows to obtain rubber particles with average volumetric diameters according to the present disclosure. It should also be noted that, with the same weight average molecular weight (M_{w}) of rubber used (see Tables 2b, 2c and 2d), it can be observed that the distribution of the average volumetric diameters of the rubber particles is also influenced by the amount of chain transfer agent n-dodecylmercaptan (NDM), added before phase inversion [i.e. in the first Plug Flow Reactor (PFR) (R1)]. In fact:
too low amounts of n-dodecylmercaptan (NDM) in the first plug flow reactor (PFR) (R1) give rise to LCBR rubber particles with small to medium volumetric diameter [Example 5 (comparative), Example 8 (comparative) and Example 11 (comparative)] and consequently to products characterised by low impact resistance values and low puncture resistance values;
by increasing the amount of n-dodecylmercaptan (NDM) in the first plug flow reactor (PFR) (R1), it is observed how the average volumetric diameter of the LCBR rubber particles increases [Example 6 (disclosure), Example 9 (disclosure) and Example 12 (disclosure)] and consequently an improvement of the mechanical properties is observed [in particular, in terms of impact resistance and puncture resistance] without observing a deterioration of the aesthetic properties [in particular, in terms of gloss and gloss sensitivity];
by further increasing the amount of n-dodecylmercaptan (NDM) in the first plug flow reactor (PFR) (R1) we can observe as a further increase in the average volumetric diameter of the LCBR rubber particles [Example 7 (comparative), Example 10 (comparative) and Example 13 (comparative) lead to a deterioration of the mechanical properties [in particular, in terms of puncture resistance and aesthetics.

It should be noted that the combination between the weight average molecular weight (M_{w}) of the functionalised low cis polybutadiene rubber (LCBR) used and the weight average molecular weight (M_{w}) of the styrene-acrylonitrile (SAN) copolymer at the inversion phase [determined by the amount of n-dodecylmercaptan (NDM) used in the first plug flow reactor (PFR) (R1) used], allows to obtain the correct volumetric distribution of the rubber particles, thus such as the right percentage of rubber particles with a volumetric diameter greater than 0.40 μm and the correct ratio between rubber particles containing occlusions and rubber particles without occlusions (Particles containing occlusions/Particles without occlusions).

Furthermore, the ratio reported above, i.e.:

$$0.15 {µm}^{3} \leq \frac{Mw {LCBR}_{l} * \frac{4}{3} * π * {( {D}_{vm} )}^{3} * \% {Particles}_{> 0.4 μ m} * NSG}{Mw SAN * {Ratio}_{occluded Part . / non - occluded Part .}} \leq 0.75 {µm}^{3}$$

is met only in the case of the rubber-reinforced vinyl aromatic copolymer obtained according to the present disclosure, as shown in Tables 2a-2d.

1. A rubber-reinforced vinyl aromatic (co)polymer comprising:
(a) a polymeric matrix comprising at least one vinyl aromatic monomer and at least one comonomer;
(b) rubber particles obtained by a continuous mass process from functionalised low cis polybutadiene rubber (LCBR) dispersed therein, wherein:
(i) the average volumetric diameter of said rubber particles is between 0.25 □m and 0.37 □m;
(ii) the volume of said rubber particles having a diameter greater than 0.40 □m is between 20% and 50%, with respect to the total volume of the dispersed rubber particles; and
(iii) the ratio between rubber particles containing occlusions and rubber particles without occlusions is between 0.9 and 1.9.

2. The rubber-reinforced vinyl aromatic (co)polymer according to claim 1, wherein said vinyl aromatic monomer is selected from the vinyl aromatic monomers having general formula (I): 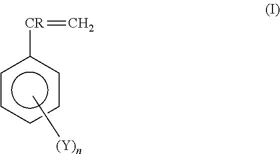
wherein R is a hydrogen atom or a methyl group, n is zero or an integer between 1 and 5, Y is a halogen atom such as chlorine, bromine, or an alkyl or alkoxy group having from 1 to 4 carbon atoms.

3. The rubber-reinforced vinyl aromatic (co)polymer according to claim 2, wherein said vinyl aromatic monomer having general formula (I) is selected from: styrene, □-methylstyrene, methylstyrene, ethylstyrene, butylstyrene, dimethylstyrene, mono-, di-, tri-, tetra- and penta-chlorostyrene, bromo-styrene, methoxy-styrene, acetoxy-styrene, or mixtures thereof.

4. The rubber-reinforced vinyl aromatic (co)polymer according to claim 1, wherein said comonomer is selected from: (meth)acrylic acid; C₁-C₄ alkyl esters of (meth)acrylic acid such as methylacrylate, methylmethacrylate, ethylacrylate, ethylmethacrylate, iso-propyl acrylate, butyl acrylate; amides and nitriles of (meth)acrylic acid such as acrylamide, methacrylamide, acrylonitrile, methacrylonitrile; imides such as N-phenyl maleimide; divinylaromatic monomers such as divinylbenzene; anhydrides such as maleic anhydride; or mixtures thereof.

5. The rubber-reinforced vinyl aromatic (co)polymer according to claim 1, wherein in said rubber-reinforced vinyl aromatic (co)polymer, the polymeric matrix comprising at least one vinyl aromatic monomer and at least one comonomer, has a weight average molecular weight (M_{w}) less than or equal to 145000 g/mole.

6. The rubber-reinforced vinyl aromatic (co)polymer according to claim 1, wherein in said rubber-reinforced vinyl aromatic (co)polymer, the functionalised low cis polybutadiene rubber (LCBR) is present in an amount between 5% by weight and 35% by weight, with respect to the total weight of the rubber-reinforced vinyl aromatic (co)polymer.

7. The rubber-reinforced vinyl aromatic (co)polymer according to claim 1, wherein, in said rubber-reinforced vinyl aromatic (co)polymer, the rubber particles obtained through a continuous mass process from functionalised low cis polybutadiene rubber (LCBR) are obtained from a functionalised low cis polybutadiene rubber (LCBR) having the following characteristics:
weight average molecular weight (M_{w}) between 40000 g/mole and 110000 g/mole;
polydispersity index (PDI), i.e. the ratio between the weight average molecular weight (M_{w}) and the number average molecular weight (Mₙ) (M_{w}/Mₙ), less than or equal to 1.4;
isomeric composition of the double bonds in the rubber chains (microstructure): content of 1,4-cis units between 10% by weight and 70% by weight; content of 1,4-trans units between 20% by weight and 80% by weight; 1,2-vinyl unit content between 0% by weight and 25% by weight;
said low cis polybutadiene rubber (LCBR) being functionalised with a functional group capable of promoting controlled-chain radical polymerisation mediated by stable free nitroxyl radicals; and said low cis polybutadiene rubber (LCBR) having a number of functional groups per rubber polymer chain less than or equal to 1.

8. The rubber-reinforced vinyl aromatic (co)polymer according to claim 1, wherein, in said rubber-reinforced vinyl aromatic (co)polymer:
the weight average molecular weight (M_{w}) of the free functionalised low cis polybutadiene rubber (LCBR) is between 8000 g/mole and 70000 g/mole;
the polydispersity index (PDI), that is the ratio between the weight average molecular weight (M_{w}) and the number average molecular weight (Mₙ) (M_{w}/Mₙ), of free functionalised low cis polybutadiene rubber (LCBR) is greater than or equal to 1.3;
the isomeric composition of the double bonds of free functionalised low cis polybutadiene rubber (LCBR) (microstructure) is as follows: content of 1,4-cis units between 10% by weight and 70% by weight; content of 1,4-trans units between 20% by weight and 800% by weight; content of 1,2-vinyl unit between 0% by weight and 25% by weight.

9. The rubber-reinforced vinyl aromatic (co)polymer according to claim 1, wherein in said rubber-reinforced vinyl aromatic (co)polymer the weight average molecular weight (M_{w}) of free functionalised low cis polybutadiene rubber (LCBR) (M_{w} LCBR₁, expressed in g/mole), the average volumetric diameter of the rubber particles (Dᵥₘ, expressed in □m), the volume of rubber particles having a diameter greater than 0.40 □m (% Particles_{>0.4 □m}), the ratio of rubber particles containing occlusions and rubber particles without occlusions (Ratio_{occluded Part./non-occluded Part.}) and the weight average molecular weight (M_{w}) of the polymeric matrix (M_{w} SAN, expressed in g/mole), are linked by the following relation:
$$0.15 {µm}^{3} \leq \frac{Mw {LCBR}_{l} * \frac{4}{3} * π * {( {D}_{vm} )}^{3} * \% {Particles}_{> 0.4 μ m} * NSG}{Mw SAN * {Ratio}_{occluded Part . / non - occluded Part .}} \leq 0.75 {µm}^{3} ,$$
□ being equal to 3.14 and the term NSG being defined according to the following formula:
$$NSG = \frac{\begin{matrix}No . of moles of stable free radical \\ containing a free ( NO ) ( III ) nitroxyl radical\end{matrix}}{No . of moles of LCBR}$$

10. The rubber-reinforced vinyl aromatic (co)polymer according to claim 1, wherein said rubber-reinforced vinyl aromatic (co)polymer has the following properties:
a gloss value, measured at 20°, greater than or equal to 50;
a gloss sensitivity less than or equal to 0.7;
an impact resistance, measured at 23° C., greater than or equal to 12 kJ/m²; and
a puncture resistance, calculated as the product of displacement at break (expressed in mm) for the energy at break (expressed in J), greater than or equal to 400 J*mm.

11. A process for the preparation of a rubber-reinforced vinyl aromatic (co)polymer, the process including the following steps:
(a) obtaining a functionalised low cis polybutadiene rubber (LCBR) with a weight average molecular weight (M_{w}) between 40000 g/mole and 110000 g/mole, in a low boiling solvent;
(b) discontinuously exchanging the low boiling solvent with a vinyl aromatic monomer;
(c) storing the solution of functionalised low cis polybutadiene rubber (LCBR) in vinylaromatic monomer in a buffer tank, according to the functionalised low cis polybutadiene rubber (LCBR) grade obtained;
(d) feeding an aliquot of the solution of functionalised low cis polybutadiene rubber (LCBR) in vinylaromatic monomer stored in the buffer tank to a vessel and add a further aliquot of vinyl aromatic monomer to reach the desired concentration of rubber in the reaction mixture, at least one solvent, at least one radical polymerisation initiator, at least one chain transfer agent and further conventional additives;
(e) continuously feeding the solution obtained in step (d) to a first plug flow reactor (PFR) (R1) and immediately before entering said first reactor (R1) feeding a stream containing at least one comonomer;
(f) continuously feeding the reaction mixture leaving said first reactor (R1) to a second plug flow reactor (PFR) (R2) to which it is also continuously fed a solution of at least one chain transfer agent in solvent; and
(g) recovering the rubber-reinforced vinyl aromatic (co)polymer from the polymerisation plant;
whereby the weight average molecular weight (M_{w}) of the functionalised low cis polyutadiene rubber (LCBR) (expressed in g/mole), the amount of chain transfer agent fed to the first plug flow reactor (PFR) (R1) [step (e)] (expressed in ppm, i.e. amount by weight of chain transfer agent fed with respect to the total weight of the compounds fed in said [step (e)]) and the average volumetric diameter of the functionalised low cis polybutadiene rubber (LCBR) particles (expressed in □m) are linked by the following relation:
$$0.5 \frac{( g / moles ) * ppm}{{µm}^{3}} \leq \frac{( {M}_{w} ) LCBR * Chain transfer agent in R 1}{{( Average volumetric diameter of rubber particles )}^{3}} \leq 1.6 \frac{( g / {moles}^{s} ) * ppm}{{µm}^{3}} ,$$

12. The process for the preparation of a rubber-reinforced vinyl aromatic (co)polymer according to claim 11, wherein:
in said step (d) the solvent is selected from aromatic solvents such as ethylbenzene, toluene, xylenes, or mixtures thereof; or from aliphatic solvents such as hexane, cyclohexane, or mixtures thereof; or mixtures thereof; and/or
in said step (d) said at least one radical initiator is added in an amount between 0% by weight and 0.7% by weight, with respect to the total weight of the reaction mixture; and/or
in said step (d) said at least one radical initiator is selected from those with an activation temperature between 40° C. and 170° C., such as 4,4′-bis-(di-iso-butyronitrile), 4,4′-bis (4-cyanopentanoic acid), 2,2′-azobis (2-amidinopropane) dihydrochloride; peroxides; hydroperoxides; percarbonates; peresters; or mixtures thereof; such as tert-butyl-iso-propyl monoperoxycarbonate, tert-butyl 2-ethylhexyl monoperoxy carbonate, dicumyl peroxide, di-tert-butyl peroxide, 1,1-di(tert-butylperoxy) cyclohexane, 1,1-di(tert-butyl peroxy)-3,3,5-trimethyl cyclohexane, (di-tert-butyl peroxy cyclohexane), tert-butyl peroxyacetate, cumyl tert-butyl peroxide, tert-butyl peroxybenzoate, tert-butyl peroxy-2-ethylhexanoate, or mixtures thereof; and/or
in said step (d) said at least one chain transfer agent is added in an amount between 0.01% by weight and 1% by weight, with respect to the total weight of the reaction mixture; and/or
in said step (d) said at least one chain transfer agent is selected from mercaptans such as n-octylmercaptan, n-dodecylmercaptan (NDM), tert-dodecylmercaptan, mercaptoethanol, or mixtures thereof; and/or
said step (d) is carried out at a temperature between 30° C. and 90° C.

13. The process for the preparation of a rubber-reinforced vinyl aromatic (co)polymer according to claim 11, wherein:
in said step (e) said at least one comonomer is added in an amount between 5% by weight and 35% by weight, with respect to the total weight of the reaction mixture, and/or
said step (e) is carried out at a temperature between 100° C. and 130° C.

14. The process for the preparation of a rubber-reinforced vinyl aromatic (co)polymer according to claim 11, wherein:
in said step (f) said at least one chain transfer agent is added in an amount between 0.5% by weight and 2.5% by weight, with respect to the total weight of the reaction mixture; and/or
said step (f) is carried out at a temperature between 120° C. and 160° C.
